(19) United States
(12) Patent Application Publication
(10) Pub. No.: US 2009/0224700 A1
(43) Pub. Date: Sep. 10, 2009

(54) Beam Transport System and Method for Linear Accelerators

(76) Inventors: Yu-Jiuan Chen, Fremont, CA (US); George J. Caporaso, Livermore, CA (US); Scott D. Nelson, Patterson, CA (US)

Correspondence Address: Lawrence Livermore National Security, LLC, LAWRENCE LIVERMORE NATIONAL LABORATORY, PO BOX 808, L-703, LIVERMORE, CA, 94551-0808, US

(21) Appl. No.: 12/136,721

(22) Filed: Jun. 10, 2008

Related U.S. Application Data
(63) Continuation-in-part of application No. 11/586,378, filed on Oct. 24, 2006.
Application No. 11/586,378 is a continuation-in-part of application No. 11/036,431, filed on Jan. 14, 2005, now Pat. No. 7,173,385.
(60) Provisional application No. 60/934,213, filed on Jun. 11, 2007.
(60) Provisional application No. 60/536,943, filed on Jan. 15, 2004.
(60) Provisional application No. 60/798,016, filed on May 4, 2006.
(60) Provisional application No. 60/730,161, filed on Oct. 24, 2005.
(60) Provisional application No. 60/730,129, filed on Oct. 24, 2005.
(60) Provisional application No. 60/730,128, filed on Oct. 24, 2005.

(51) Int. Cl. H05H 9/00

(52) U.S. Cl. 315/505

(57) ABSTRACT

A charged particle beam transport system and method for linear accelerators includes a lens stack having two electrodes serially arranged along an acceleration axis between a charged particle source, and a linear accelerator. After producing and extracting a bunch of charged particles (i.e. particle beam) from the particle source, a voltage difference between the two electrodes is ramped in time to longitudinally compress the particle beam to be shorter than the pulsewidth of acceleration pulses produced in the accelerator. Additional electrodes may be provided in the lens stack for performing transverse focusing of the charged particle bunch and controlling a final beam spot size independent of the current and energy of the particle beam. In a traveling wave accelerator embodiment having a plurality of independently switchable pulse-forming lines, beam transport can also be controlled by triggering multiple adjacent lines simultaneously so that the physical size of the accelerating electric field is longer than the charged particle bunch, as well as by controlling trigger timing of the pulse-forming lines to perform alternating phase focusing.

### CROSS-REFERENCE TO RELATED APPLICATIONS

This application claims priority in U.S. Provisional Application No. 60/934,213 filed Jun. 11, 2007. This application is also a continuation-in-part of prior application Ser. No. 11/586,378, filed Oct. 24, 2006 which is a continuation-in-part of prior application Ser. No. 11/036,431, filed Jan. 14, 2005, which claims the benefit of U.S. Provisional Application No. 60/536,943, filed Jan. 15, 2004; and application Ser. No. 11/586,378 also claims the benefit of U.S. Provisional Application Nos. 60/730,128, 60/730,129, and 60/730,161, filed Oct. 24, 2005 and U.S. Provisional Application No, 60/798,016, filed May 4, 2006, all of which are incorporated by reference herein.

### FEDERALLY SPONSORED RESEARCH OR DEVELOPMENT

The United States Government has rights in this invention pursuant to Contract No. DE-AC52-07NA27344 between the United States Department of Energy and Lawrence Livermore National Security, LLC for the operation of Lawrence Livermore National Laboratory.

### FIELD OF THE INVENTION

The present invention relates to linear accelerators, and more particularly to a charged particle beam transport system and method for linear accelerators which ramps in time a voltage difference between two electrodes of a lens stack to longitudinally compress a bunch of charged particles prior to being injected into an acceleration stage, and which also uses various switch trigger modalities in the acceleration stage for operating a plurality of independently switched pulse-forming lines to longitudinally compress/decompress and transversely focus/defocus the bunch of charged particles.

### BACKGROUND OF THE INVENTION

Particle accelerators are used to increase the energy of electrically-charged atomic particles, e.g., electrons, protons, or charged atomic nuclei, so that they can be studied by nuclear and particle physicists. High energy electrically-charged atomic particles are accelerated to collide with target atoms, and the resulting products are observed with a detector. At very high energies the charged particles can break up the nuclei of the target atoms and interact with other particles. Transformations are produced that tip off the nature and behavior of fundamental units of matter. Particle accelerators are also important tools in the effort to develop nuclear fusion devices, as well as for medical applications such as cancer therapy.

One type of particle accelerator is disclosed in U.S. Pat. No. 5,757,146 to Carder, incorporated by reference herein, for providing a method to generate a fast electrical pulse for the acceleration of charged particles. In Carder, a dielectric wall accelerator (DWA) system is shown consisting of a series of stacked circular modules which generate a high voltage when switched. Each of these modules is called an asymmetric Blumlein, which is described in U.S. Pat. No. 2,465,840 incorporated by reference herein. As can be best seen in FIGS. 4A-4B of the Carder patent, the Blumlein is composed of two different dielectric layers. On each surface and between the dielectric layers are conductors which form two parallel plate radial transmission lines. One side of the structure is referred to as the slow line, the other is the fast line. The center electrode between the fast and slow line is initially charged to a high potential. Because the two lines have opposite polarities there is no net voltage across the inner diameter (ID) of the Blumlein. Upon applying a short circuit across the outside of the structure by a surface flashover or similar switch, two reverse polarity waves are initiated which propagate radially inward towards the ID of the Blumlein. The wave in the fast line reaches the ID of the structure prior to the arrival of the wave in the slow line. When the fast wave arrives at the ID of the structure, the polarity there is reversed in that line only, resulting in a net voltage across the ID of the asymmetric Blumlein. This high voltage will persist until the wave in the slow line finally reaches the ID. In the case of an accelerator, a charged particle beam can be injected and accelerated during this time. In this manner, the DWA accelerator in the Carder patent provides an axial accelerating field that continues over the entire structure in order to achieve high acceleration gradients.

The existing dielectric wall accelerators, such as the Carder DWA, however, have certain inherent problems which can affect beam quality and performance. In particular, several problems exist in the disc-shaped geometry of the Carder DWA which make the overall device less than optimum for the intended use of accelerating charged particles. The flat planar conductor with a central hole forces the propagating wavefront to radially converge to that central hole. In such a geometry, the wavefront sees a varying impedance which can distort the output pulse, and prevent a defined time independent energy gain from being imparted to a charged particle beam traversing the electric field. Instead, a charged particle beam traversing the electric field created by such a structure will receive a time varying energy gain, which can prevent an accelerator system from properly transporting such beam, and making such beams of limited use.

Additionally, the impedance of such a structure may be far lower than required. For instance, it is often highly desirable to generate a beam on the order of milliamps or less while maintaining the required acceleration gradients. The disc-shaped Blumlein structure of Carder can cause excessive levels of electrical energy to be stored in the system. Beyond the obvious electrical inefficiencies, any energy which is not delivered to the beam when the system is initiated can remain in the structure. Such excess energy can have a detrimental effect on the performance and reliability of the overall device, which can lead to premature failure of the system.

And inherent in a flat planar conductor with a central hole (e.g. disc-shaped) is the greatly extended circumference of the exterior of that electrode. As a result, the number of parallel switches to initiate the structure is determined by that circumference. For example, in a 6″ diameter device used for producing less than a 10 ns pulse typically requires, at a minimum, 10 switch sites per disc-shaped asymmetric Blumlein layer. This problem is further compounded when long acceleration pulses are required since the output pulse length of this disc-shaped Blumlein structure is directly related to the radial extent from the central hole. Thus, as long pulse widths are required, a corresponding increase in switch sites is also required. As the preferred embodiment of initiating the switch is the use of a laser or other similar device, a highly complex distribution system is required. Moreover, a long pulse structure requires large dielectric sheets for which fabrication is difficult. This can also increase the weight of such a structure. For instance, in the present configuration, a device delivering 50 ns pulse can weigh as much as several tons per meter. While some of the long pulse disadvantages can be alleviated by the use of spiral grooves in all three of the conductors in the asymmetric Blumlein, this can result in a destructive interference layer-to-layer coupling which can inhibit the operation. That is, a significantly reduced pulse amplitude (and therefore energy) per stage can appear on the output of the structure.

Additionally, various types of accelerators have been developed for particular use in medical therapy applications, such as cancer therapy using proton beams. For example, U.S. Pat. No. 4,879,287 to Cole et al discloses a multi-station proton beam therapy system used for the Loma Linda University Proton Accelerator Facility in Loma Linda, Calif. In this system, particle source generation is performed at one location of the facility, and acceleration is performed at another location of the facility, while patients are located at still other locations of the facility. Due to the remoteness of the source, acceleration, and target from each other particle transport is accomplished using a complex gantry system with large, bulky bending magnets. And other representative systems known for medical therapy are disclosed in U.S. Pat. No. 6,407,505 to Bertsche and U.S. Pat. No. 4,507,616 to Blosser et al. In Berstche, a standing wave RF linac is shown and in Blosser a superconducting cyclotron rotatably mounted on a support structure is shown.

Furthermore, ion sources are known which create a plasma discharge from a low pressure gas within a volume. From this volume, ions are extracted and collimated for acceleration into an accelerator. These systems are generally limited to extracted current densities of below 0.25 A/cm2. This low current density is partially due to the intensity of the plasma discharge at the extraction interface. One example of an ion source known in the art is disclosed in U.S. Pat. No. 6,985,553 to Leung et al having an extraction system configured to produce ultra-short ion pulses. Another example is shown in U.S. Pat. No. 6,759,807 to Wahlin disclosing a multi-grid ion beam source having an extraction grid, an acceleration grid, a focus grid, and a shield grid to produce a highly collimated ion beam.

With regard to particle dynamics in linear accelerators, it is known that a bunch of charged particles (i.e. a particle beam) produced by a charged particle source do not all enter and travel through the accelerator at the right time and at the right velocity to be perfectly synchronous with the acceleration energies produced along the length of the accelerator. Instead, bunched particles typically have some level of beam emittance, i.e. a spread in particle velocities (momentum) as well as in a finite transverse dimension, both at the time of extraction from the particle source as well as throughout the acceleration stage in the accelerator. Beam emittance makes beam transport in an accelerator challenging, especially in accelerators which employ time-varying energy waveforms to produce acceleration gradients (for example, RF standing wave linacs which produce energy waveforms having a sinusoidal time variation, or even short pulse dielectric wall accelerators in which due to a parasitic drain of energy from the pulse-forming lines the otherwise flattop pulse shape becomes distorted). This is because the particles of a spatially dispersed bunch will experience the time-varying energy field at different times and at spatially different positions, and thus experience different forces of motion, both longitudinal and transverse, during the acceleration stage. Stated another way, because the accelerating energy waveforms are not constant in time, i.e. lack a flattop, there will be variations in energy (i.e. energy spread) imparted to different particles of a bunch depending on each particle's relative position in the bunch and the timing of each particle's encounter with the energy waveform. As a result of the energy spread, the particle bunch may experience longitudinal compression or decompression which affects the bunch length and phase stability, as well as radial or transverse focusing or defocusing which affects the bunch width (beam width) and ultimately the final beam spot size on a target. Variations in bunch length in particular can be problematic for capturing all the particles in a bunch if the bunch length is longer than the pulsewidth of the accelerating energy waveform. In the case of short pulse dielectric wall accelerators in particular which produce a very high gradient using ultrashort pulsewidths on the order of a few nanoseconds, the need to longitudinally compress the bunch length to be shorter than the pulsewidth is even greater because the magnitude of the required compression is greater.

As described in U.S. Pat. No. 2,545,595 to Alvarez, and U.S. Pat. No. 2,770,755 to Good, an inverse relationship is known to exist between longitudinal compression (phase stability) and transverse focusing (transverse stability) of an accelerated particle bunch. FIG. 2 of the Good patent illustrates this relationship. As shown there, particles exposed to the time-varying energy field along the rising edge of the accelerating energy waveform will undergo longitudinal compression (phase stable) and radial defocusing (transversely unstable), while particles experiencing the time-varying energy field along the falling edge of the accelerating energy waveform will undergo longitudinal decompression or expansion (phase unstable) and radial focusing (transversely stable). In the Alvarez patent in particular, a thin metallic foil 12 is placed over the entry end of the drift tubes, as shown in FIG. 5 of Alvarez, in order to distort the electric field and thereby achieve radial focusing during phase stable operation. In addition, external magnetic fields, such as those produced by solenoids or quadrupoles, have also been used to control transverse motion within the accelerating aperture of the linac.

Alternating phase focusing (APF) beam transport methodologies have also been employed to address the incompatibility between phase stability and radial focusing in the acceleration stage. Generally, an APF operation modulates in the acceleration stage the exposure of a particle bunch to either the rising edge or falling edge of an accelerating energy waveform, so as to cause a corresponding longitudinal compression with radial defocusing, or longitudinal decompression with radial focusing. In this manner, a particle beam can be accelerated while at the same time experiencing a succession of transverse focusing and defocusing forces which result in a suitable level of containment of the beam without dependence on magnetic focusing fields. APF has been addressed in the context of both drift tube RF standing wave linacs having a discrete number of accelerating gaps spaced in a predetermined manner to achieve a particular value of the synchronous phase in each gap, as well as ion linacs with short independently controlled superconducting cavities which produce a continuously phase modulated “traveling wave” electric field.

U.S. Pat. No. 4,211,954 to Swenson and the '755 patent to Good are two examples of APF in the drift tube RF standing wave linac context. In the Good patent in particular, drift tubes are used having lengths that are either less than or greater than the normal synchronous length, and which are alternatingly positioned at the 2^{nd}, 6^{th}, and 10^{th} drift tube positions. This arrangement operates to cause radial focusing and longitudinal decompression at the gaps following each of the 2^{nd}, 6^{th}, and 10^{th} drift tube positions, while radial defocusing and longitudinal compression occurs at the gaps following all other drift tubes. And the publication, “Investigation of Alternating-Phase Focusing for Superconducting Linacs” by Sagalovsky et al, Jan. 1, 1992 is an example of APF addressed in the continuously phase-modulated, traveling wave accelerator context. In particular, the Sagalovsky publication discloses an analytical APF model describing the physics of APF in linacs with low-β superconducting cavities which are independently controlled to adjust both the phase and the amplitude of the electric field. It is appreciated that in such traveling wave linacs, each cavity typically has an axial length (and thus an accelerating electric field) that is much longer that the physical length of the injected bunch of particles so that the entire particle bunch may be captured.

Prior to being injected into the acceleration stage of the accelerator, however, it is also known that a bunch of ion particles (i.e. particle beam) emerging from an ion particle source typically has a divergent shape. Therefore, for efficient utilization of the accelerator, it is often necessary to transversely focus the particle beam in flight prior to entering the acceleration stage. Various electrostatic and magnetic methods of ion beam transverse focusing are known. For example, Einzel lens, comprising three or more sets of typically cylindrically shaped electrodes arranged in series along an axis, are often used to produce curved electric field lines between the electrodes of opposite polarity to create a single lens. In particular, Einzel lens are typically configured to produce a defocusing-focusing-defocusing region so that the net effect is always positive focusing, i.e. a converging lens. While Einzel lens are frequently used at the injection end of tandem accelerators, they are considered not practical for beam handling and transport for high-energy applications except in very low-voltage accelerators. As such, Einzel lens are typically used for initial conditioning of the beam size, but not to control final beam spot size which is often handled at the acceleration stage. Moreover, while Einzel lens have been used for transverse focusing, as known in the art, they have not been used for performing longitudinal bunch compression.

It would therefore be advantageous to provide an improved beam transport system and method which is capable of modulating beam emittance at the extraction stage prior to injection into the acceleration stage as well as during the acceleration stage, in a manner which enables efficient acceleration of the particle beam through the accelerator (especially short pulse dielectric wall type accelerators using individually controllable pulse-forming lines) as well as control of the final beam spot size at the target. In particular, it would be advantageous to provide a system and method for longitudinally compressing the particle bunch prior to injection into the acceleration stage in order to enable capture of the bunch near the crest of a time-varying electric field and with a low energy spread.

### SUMMARY OF THE INVENTION

One aspect of the present invention includes a linear accelerator system comprising: a charged particle source for producing a bunch of charged particles; a linear accelerator for producing at least one acceleration gradient along an acceleration axis; a lens stack having two electrodes serially arranged along the acceleration axis between the charged particle source and the linear accelerator; and voltage controller means for ramping in time a voltage difference produced between the two electrodes so that upstream particles of the bunch have a greater kinetic energy than downstream particles so as to longitudinally compress the bunch of charged particles prior to being injected into the linear accelerator.

Another aspect of the present invention includes a short pulse dielectric wall accelerator system comprising: a pulsed ion source for producing a bunch of charged particles; a dielectric wall beam tube surrounding an acceleration axis and having an inlet end and an outlet end; a plurality of pulse-forming lines transversely connected to and serially arranged along the dielectric wall beam tube, each pulse-forming line having a switch connectable to a high voltage potential for propagating at least one electrical wavefront(s) through the pulse-forming line independently from other pulse-forming lines to produce a short acceleration pulse adjacent a corresponding short axial length of the dielectric wall beam tube; a lens stack comprising two longitudinal compression electrodes, and at least one transverse focusing electrode(s), all of which are serially arranged along the acceleration axis between the pulsed ion source and the inlet end of the dielectric wall beam tube; voltage controller means for ramping in time a voltage difference produced between the two longitudinal compression electrodes so that upstream particles of the bunch have a greater kinetic energy than downstream particles so as to longitudinally compress the bunch of charged particles prior to being injected into the linear accelerator, and for controlling the voltages of the transverse focusing electrode(s) to control the transverse focusing of the bunch of charged particles prior to being injected into the linear accelerator and to thereby control a beam spot size independent of the current and energy of the bunch of charged particles; and a trigger controller for sequentially activating said switches in groups of at least one switch(es) corresponding to a block of adjacent pulse-forming line(s) so that the groups of short acceleration pulses sequentially produced by said switch groups form a traveling axial electric field that propagates along the acceleration axis in substantial synchronism with the injected bunch of charged particles to serially impart acceleration energy thereto.

Another aspect of the present invention includes a beam transport method for longitudinally compressing a bunch of charged particles produced by a charged particle source, comprising: providing two longitudinal compression electrodes and at least one transverse focusing electrode(s) serially arranged along the acceleration axis adjacent the charged particle source; ramping in time a voltage difference produced between first and second electrodes so that upstream particles of the bunch have a greater kinetic energy than downstream particles so as to longitudinally compress the bunch of charged particles while in flight along the acceleration axis; and controlling the voltages of the transverse focusing electrode(s) to control the transverse focusing of the bunch of charged particles while in flight along the acceleration axis.

Another aspect of the present invention includes a beam transport method for linear accelerators comprising: providing a linear accelerator system comprising: a charged particle source; a linear accelerator for producing at least one acceleration gradient along an acceleration axis; and a lens stack comprising two electrodes which are serially arranged along the acceleration axis between the charged particle source and the linear accelerator; producing a bunch of charged particles from said charged particle source; extracting the bunch of charged particles into the lens stack; ramping in time a voltage difference produced between the two electrodes so that upstream particles of the bunch have a greater kinetic energy than downstream particles so as to longitudinally compress the bunch of charged particles prior to being injected into the linear accelerator; and injecting the longitudinally compressed bunch of charged particles into the linear accelerator.

### BRIEF DESCRIPTION OF THE DRAWINGS

The accompanying drawings, which are incorporated into and form a part of the disclosure, are as follows:

FIG. 1 is a side view of a first exemplary embodiment of a single Blumlein module of the compact accelerator of the present invention.

FIG. 2 is top view of the single Blumlein module of FIG. 1.

FIG. 3 is a side view of a second exemplary embodiment of the compact accelerator having two Blumlein modules stacked together.

FIG. 4 is a top view of a third exemplary embodiment of a single Blumlein module of the present invention having a middle conductor strip with a smaller width than other layers of the module.

FIG. 5 is an enlarged cross-sectional view taken along line 4 of FIG. 4.

FIG. 6 is a plan view of another exemplary embodiment of the compact accelerator shown with two Blumlein modules perimetrically surrounding and radially extending towards a central acceleration region.

FIG. 7 is a cross-sectional view taken along line 7 of FIG. 6.

FIG. 8 is a plan view of another exemplary embodiment of the compact accelerator shown with two Blumlein modules perimetrically surrounding and radially extending towards a central acceleration region, with planar conductor strips of one module connected by ring electrodes to corresponding planar conductor strips of the other module.

FIG. 9 is a cross-sectional view taken along line 9 of FIG. 8.

FIG. 10 is a plan view of another exemplary embodiment of the present invention having four non-linear Blumlein modules each connected to an associated switch.

FIG. 11 is a plan view of another exemplary embodiment of the present invention similar to FIG. 10, and including a ring electrode connecting each of the four non-linear Blumlein modules at respective second ends thereof.

FIG. 12 is a side view of another exemplary embodiment of the present invention similar to FIG. 1, and having the first dielectric strip and the second dielectric strip having the same dielectric constants and the same thicknesses, for symmetric Blumlein operation.

FIG. 13 is schematic view of an exemplary embodiment of the charged particle generator of the present invention.

FIG. 14 is an enlarged schematic view taken along circle 14 of FIG. 13, showing an exemplary embodiment of the pulsed ion source of the present invention.

FIG. 15 shows a progression of pulsed ion generation by the pulsed ion source of FIG. 14.

FIG. 16 shows multiple screen shots of final spot sizes on the target for various gate electrode voltages.

FIG. 17 shows a graph of extracted proton beam current as a function of the gate electrode voltage on a high-gradient proton beam accelerator.

FIG. 18 shows two graphs showing potential contours in the charged particle generator of the present invention.

FIG. 19 is a comparative view of beam transport in a magnet-free 250 MeV high-gradient proton accelerator with various focus electrode voltage settings.

FIG. 20 is a comparative view of four graphs of the edge beam radii (upper curves) and the core radii (lower curves) on the target versus the focus electrode voltage for 250 MeV, 150 MeV, 100 MeV, and 70 MeV proton beams.

FIG. 21 is a schematic view of the actuable compact accelerator system of the present invention having an integrated unitary charged particle generator and linear accelerator.

FIG. 22 is a side view of an exemplary mounting arrangement of the unitary compact accelerator/charged particle source of the present invention, illustrating a medical therapy application.

FIG. 23 is a perspective view of an exemplary vertical mounting arrangement of the unitary compact accelerator/charged particle source of the present invention.

FIG. 24 is a perspective view of an exemplary hub-spoke mounting arrangement of the unitary compact accelerator/charged particle source of the present invention.

FIG. 25 is a schematic view of a sequentially pulsed traveling wave accelerator of the present invention.

FIG. 26 is a schematic view illustrating a short pulse traveling wave operation of the sequentially pulsed traveling wave accelerator of FIG. 25.

FIG. 27 is a schematic view illustrating a long pulse operation of a typical cell of a conventional dielectric wall accelerator.

FIG. 28 is a graph showing a first exemplary ramping in time of a voltage difference between two electrodes performing longitudinal compression of a positively charged particle bunch via bunch acceleration.

FIG. 29 is a graph showing a second exemplary ramping in time of a voltage difference between two electrodes performing longitudinal compression of a positively charged particle bunch via bunch deceleration.

FIG. 30 is a graph showing a third exemplary ramping in time of a voltage difference between two electrodes performing longitudinal compression of a negatively charged particle bunch via bunch acceleration.

FIG. 31 is a graph showing a fourth exemplary ramping in time of a voltage difference between two electrodes performing longitudinal compression of a negatively charged particle bunch via bunch deceleration.

FIG. 32 a schematic view of an exemplary sequentially pulsed traveling wave accelerator of the present invention having sequential triggering in blocks of two adjacent transmission lines to produce a larger acceleration bucket, and also illustrating alternating phase focusing by varying trigger timing.

### DETAILED DESCRIPTION

### A. Compact Accelerator with Strip-Shaped Blumlein

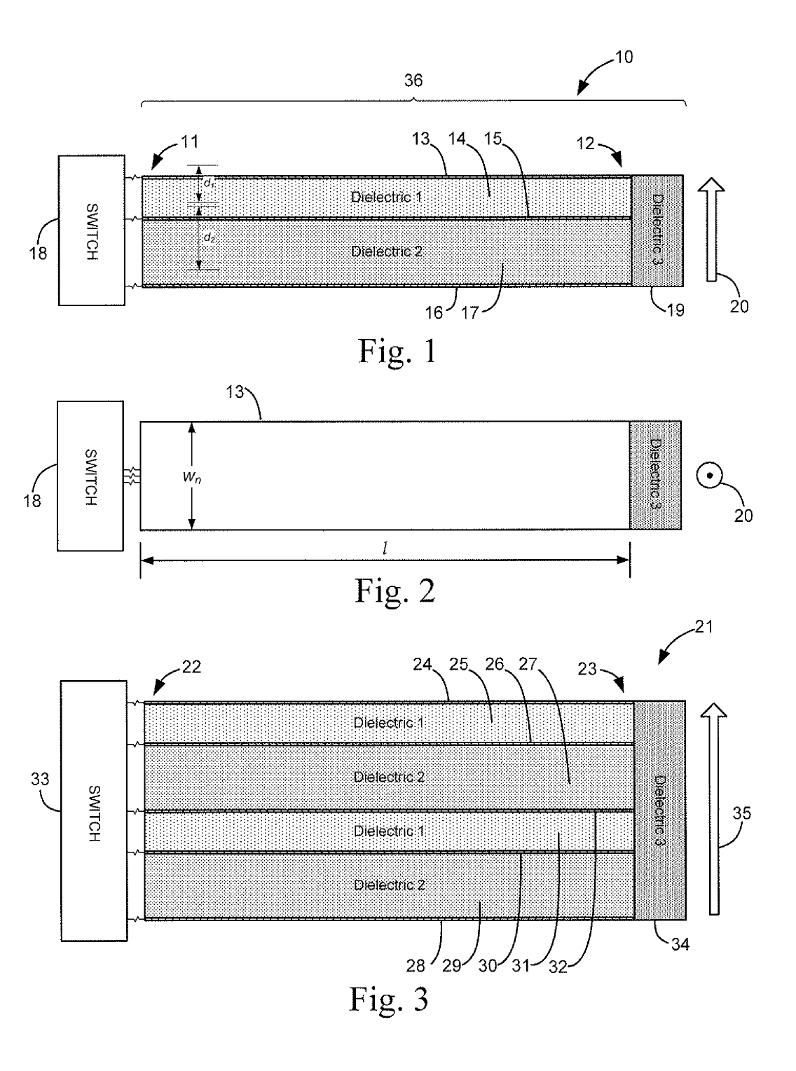

Turning now to the drawings, FIGS. 1-12 show a compact linear accelerator used in the present invention, having at least one strip-shaped Blumlein module which guides a propagating wavefront between first and second ends and controls the output pulse at the second end. Each Blumlein module has first second, and third planar conductor strips, with a first dielectric strip between the first and second conductor strips, and a second dielectric strip between the second and third conductor strips. Additionally, the compact linear accelerator includes a high voltage power supply connected to charge the second conductor strip to a high potential, and a switch for switching the high potential in the second conductor strip to at least one of the first and third conductor strips so as to initiate a propagating reverse polarity wavefront(s) in the corresponding dielectric strip(s).

The compact linear accelerator has at least one strip-shaped Blumlein module which guides a propagating wavefront between first and second ends and controls the output pulse at the second end. Each Blumlein module has first, second, and third planar conductor strips, with a first dielectric strip between the first and second conductor strips, and a second dielectric strip between the second and third conductor strips. Additionally, the compact linear accelerator includes a high voltage power supply connected to charge the second conductor strip to a high potential, and a switch for switching the high potential in the second conductor strip to at least one of the first and third conductor strips so as to initiate a propagating reverse polarity wavefront(s) in the corresponding dielectric strip(s).

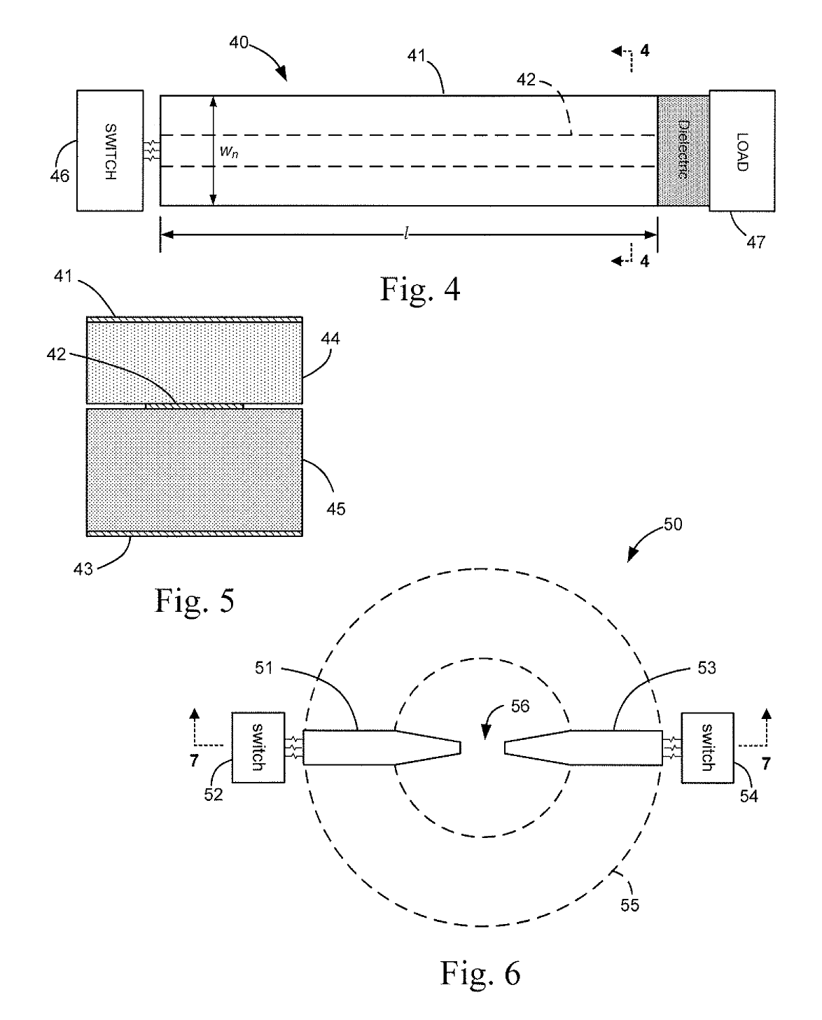

FIGS. 1-2 show a first exemplary embodiment of the compact linear accelerator, generally indicated at reference character 10, and comprising a single Blumlein module 36 connected to a switch 18. The compact accelerator also includes a suitable high voltage supply (not shown) providing a high voltage potential to the Blumlein module 36 via the switch 18. Generally, the Blumlein module has a strip configuration, i.e. a long narrow geometry, typically of uniform width but not necessarily so. The particular Blumlein module 11 shown in FIGS. 1 and 2 has an elongated beam or plank-like linear configuration extending between a first end 11 and a second end 12, and having a relatively narrow width, wₙ (FIGS. 2, 4) compared to the length, l. This strip-shaped configuration of the Blumlein module operates to guide a propagating electrical signal wave from the first end 11 to the second end 12, and thereby control the output pulse at the second end. In particular, the shape of the wavefront may be controlled by suitably configuring the width of the module, e.g. by tapering the width as shown in FIG. 6. The strip-shaped configuration enables the compact accelerator to overcome the varying impedance of propagating wavefronts which can occur when radially directed to converge upon a central hole as discussed in the Background regarding disc-shaped module of Carder. And in this manner, a flat output (voltage) pulse can be produced by the strip or beam-like configuration of the module 10 without distorting the pulse, and thereby prevent a particle beam from receiving a time varying energy gain. As used herein and in the claims, the first end 11 is characterized as that end which is connected to a switch, e.g. switch 18, and the second end 12 is that end adjacent a load region, such as an output pulse region for particle acceleration.

As shown in FIGS. 1 and 2, the narrow beam-like structure of the basic Blumlein module 10 includes three planar conductors shaped into thin strips and separated by dielectric material also shown as elongated but thicker strips. In particular, a first planar conductor strip 13 and a middle second planar conductor strip 15 are separated by a first dielectric material 14 which fills the space therebetween. And the second planar conductor strip 15 and a third planar conductor strip 16 are separated by a second dielectric material 17 which fills the space therebetween. Preferably, the separation produced by the dielectric materials positions the planar conductor strips 13, 15 and 16 to be parallel with each other as shown. A third dielectric material 19 is also shown connected to and capping the planar conductor strips and dielectric strips 13-17. The third dielectric material 19 serves to combine the waves and allow only a pulsed voltage to be across the vacuum wall, thus reducing the time the stress is applied to that wall and enabling even higher gradients. It can also be used as a region to transform the wave, i.e., step up the voltage, change the impedance, etc. prior to applying it to the accelerator. As such, the third dielectric material 19 and the second end 12 generally, are shown adjacent a load region indicated by arrow 20. In particular, arrow 20 represents an acceleration axis of a particle accelerator and pointing in the direction of particle acceleration. It is appreciated that the direction of acceleration is dependent on the paths of the fast and slow transmission lines, through the two dielectric strips, as discussed in the Background.

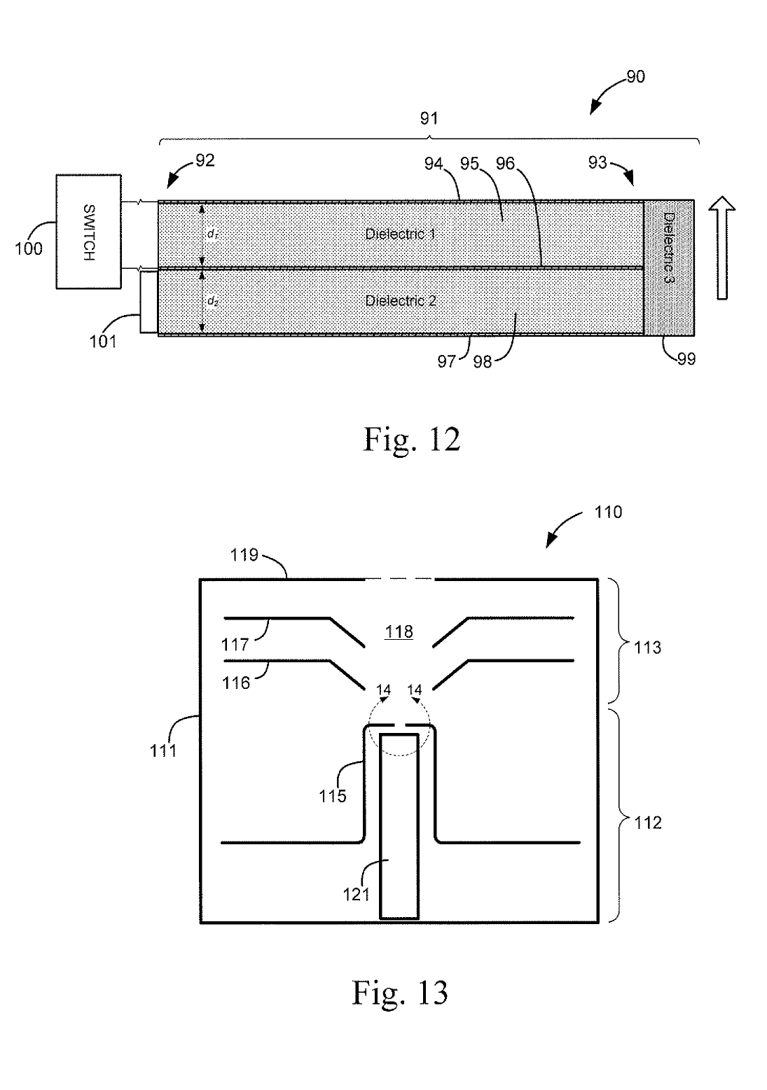

In FIG. 1, the switch 18 is shown connected to the planar conductor strips 13, 15, and 16 at the respective first ends, i.e. at first end 11 of the module 36. The switch serves to initially connect the outer planar conductor strips 13, 16 to a ground potential and the middle conductor strip 15 to a high voltage source (not shown). The switch 18 is then operated to apply a short circuit at the first end so as to initiate a propagating voltage wavefront through the Blumlein module and produce an output pulse at the second end. In particular, the switch 18 can initiate a propagating reverse polarity wavefront in at least one of the dielectrics from the first end to the second end, depending on whether the Blumlein module is configured for symmetric or asymmetric operation. When configured for asymmetric operation, as shown in FIGS. 1 and 2, the Blumlein module comprises different dielectric constants and thicknesses (d₁≠d₂) for the dielectric layers 14, 17, in a manner similar to that described in Carder. The asymmetric operation of the Blumlein generates different propagating wave velocities through the dielectric layers. However, when the Blumlein module is configured for symmetric operation as shown in FIG. 12, the dielectric strips 95, 98 are of the same dielectric constant, and the width and thickness (d₁=d₂) are also the same. In addition, as shown in FIG. 12, a magnetic material is also placed in close proximity to the second dielectric strip 98 such that propagation of the wavefront is inhibited in that strip. In this manner, the switch is adapted to initiate a propagating reverse polarity wavefront in only the first dielectric strip 95. It is appreciated that the switch 18 is a suitable switch for asymmetric or symmetric Blumlein module operation, such as for example, gas discharge closing switches, surface flashover closing switches, solid state switches, photoconductive switches, etc. And it is further appreciated that the choice of switch and dielectric material types/dimensions can be suitably chosen to enable the compact accelerator to operate at various acceleration gradients, including for example gradients in excess of twenty megavolts per meter. However, lower gradients would also be achievable as a matter of design.

In one preferred embodiment, the second planar conductor has a width, w₁ defined by characteristic impedance Z₁=k₁g₁(w₁,d₁) through the first dielectric strip. k₁ is the first electrical constant of the first dielectric strip defined by the square root of the ratio of permeability to permittivity of the first dielectric material, g₁ is the function defined by the geometry effects of the neighboring conductors, and d₁ is the thickness of the first dielectric strip. And the second dielectric strip has a thickness defined by characteristic impedance Z₂=k₂g₂(w₂, d₂) through the second dielectric strip. In this case, k₂ is the second electrical constant of the second dielectric material, g₂ is the function defined by the geometry effects of the neighboring conductors, and w₂ is the width of the second planar conductor strip, and d₂ is the thickness of the second dielectric strip. In this manner, as differing dielectrics required in the asymmetric Blumlein module result in differing impedances, the impedance can now be hold constant by adjusting the width of the associated line. Thus greater energy transfer to the load will result.

FIGS. 4 and 5 show an exemplary embodiment of the Blumlein module having a second planar conductor strip 42 with a width that is narrower than those of the first and second planar conductor strips 41, 42, as well as first and second dielectric strips 44, 45. In this particular configuration, the destructive interference layer-to-layer coupling discussed in the Background is inhibited by the extension of electrodes 41 and 43 as electrode 42 can no longer easily couple energy to the previous or subsequent Blumlein. Furthermore, another exemplary embodiment of the module preferably has a width which varies along the lengthwise direction, l, (see FIGS. 2, 4) so as to control and shape the output pulse shape. This is shown in FIG. 6 showing a tapering of the width as the module extends radially inward towards the central load region. And in another preferred embodiment, dielectric materials and dimensions of the Blumlein module are selected such that, Z₁ is substantially equal to Z₂. As previously discussed, match impedances prevent the formation of waves which would create an oscillatory output.

And preferably, in the asymmetric Blumlein configuration, the second dielectric strip 17 has a substantially lesser propagation velocity than the first dielectric strip 14, such as for example 3:1, where the propagation velocities are defined by ν₂, and ν₁, respectively, where ν₂=(μ₂ε₂)^{-0.5} and ν₁=(μ₁ε₁)^{-0.5}; the permeability, μ₁, and the permittivity, ε₁, are the material constants of the first dielectric material; and the permeability, μ₂, and the permittivity, ε₂, are the material constants of the second dielectric material. This can be achieved by selecting for the second dielectric strip a material having a dielectric constant, i.e. μ₁ε₁, which is greater than the dielectric constant of the first dielectric strip, i.e. μ₂ε₂. As shown in FIG. 1, for example, the thickness of the first dielectric strip is indicated as d₁, and the thickness of the second dielectric strip is indicated as d₂, with d₂ shown as being greater than d₁. By setting d₂ greater than d₁, the combination of different spacing and the different dielectric constants results in the same characteristic impedance, Z, on both sides of the second planar conductor strip 15. It is notable that although the characteristic impedance may be the same on both halves, the propagation velocity of signals through each half is not necessarily the same. While the dielectric constants and the thicknesses of the dielectric strips may be suitably chosen to effect different propagating velocities, it is appreciated that the elongated strip-shaped structure and configuration need not utilize the asymmetric Blumlein concept, i.e. dielectrics having different dielectric constants and thicknesses. Since the controlled waveform advantages are made possible by the elongated beam-like geometry and configuration of the Blumlein modules, and not by the particular method of producing the high acceleration gradient, another exemplary embodiment can employ alternative switching arrangements, such as that discussed for FIG. 12 involving symmetric Blumlein operation.

The compact accelerator may alternatively be configured to have two or more of the elongated Blumlein modules stacked in alignment with each other. For example, FIG. 3 shows a compact accelerator 21 having two Blumlein modules stacked together in alignment with each other. The two Blumlein modules form an alternating stack of planar conductor strips and dielectric strips 24-32, with the planar conductor strip 32 common to both modules. And the conductor strips are connected at a first end 22 of the stacked module to a switch 33. A dielectric wall is also provided at 34 capping the second end 23 of the stacked module, and adjacent a load region indicated by acceleration axis arrow 35.

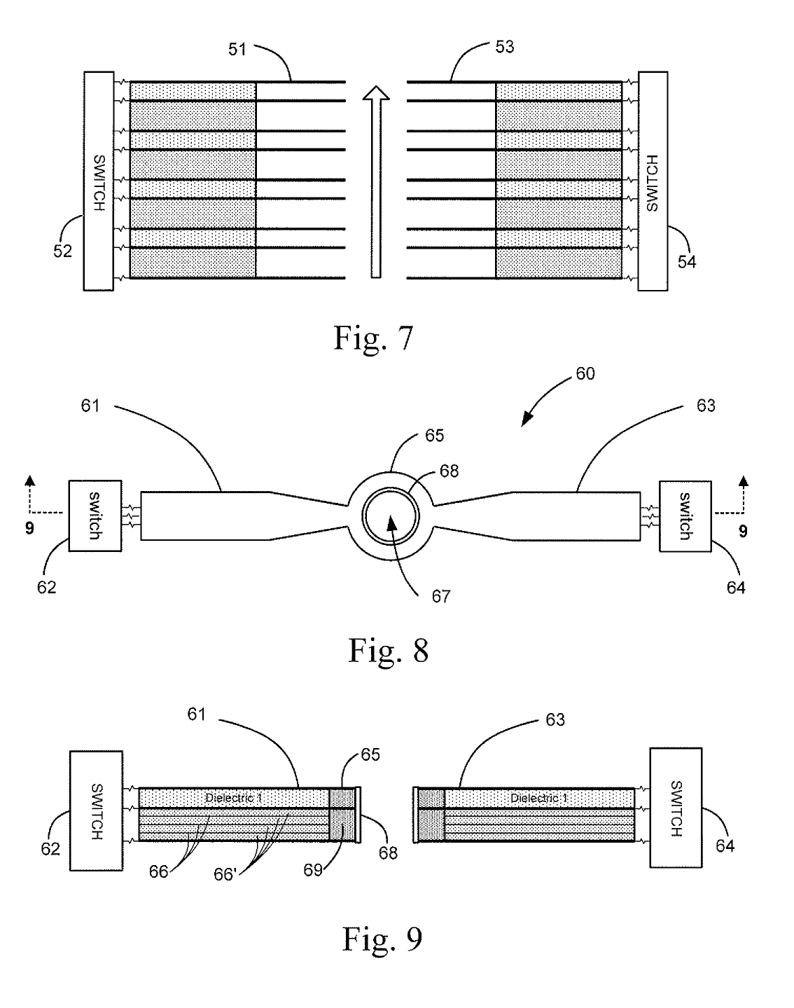

The compact accelerator may also be configured with at least two Blumlein modules which are positioned to perimetrically surround a central load region. Furthermore, each perimetrically surrounding module may additionally include one or more additional Blumlein modules stacked to align with the first module. FIG. 6, for example, shows an exemplary embodiment of a compact accelerator 50 having two Blumlein module stacks 51 and 53, with the two stacks surrounding a central load region 56. Each module stack is shown as a stack of four independently operated Blumlein modules (FIG. 7), and is separately connected to associated switches 52, 54. It is appreciated that the stacking of Blumlein modules in alignment with each other increases the coverage of segments along the acceleration axis.

In FIGS. 8 and 9 another exemplary embodiment of a compact accelerator is shown at reference character 60, having two or more conductor strips, e.g. 61, 63, connected at their respective second ends by a ring electrode indicated at 65. The ring electrode configuration operates to overcome any azimuthal averaging which may occur in the arrangement of such as FIGS. 6 and 7 where one or more perimetrically surrounding modules extend towards the central load region without completely surrounding it. As best seen in FIG. 9, each module stack represented by 61 and 62 is connected to an associated switch 62 and 64, respectively. Furthermore, FIGS. 8 and 9 show an insulator sleeve 68 placed along an interior diameter of the ring electrode. Alternatively, separate insulator material 69 is also shown placed between the ring electrodes 65. And as an alternative to the dielectric material used between the conductor strips, alternating layers of conducting 66 and insulating 66′ foils may be utilized. The alternative layers may be formed as a laminated structure in lieu of a monolithic dielectric strip.

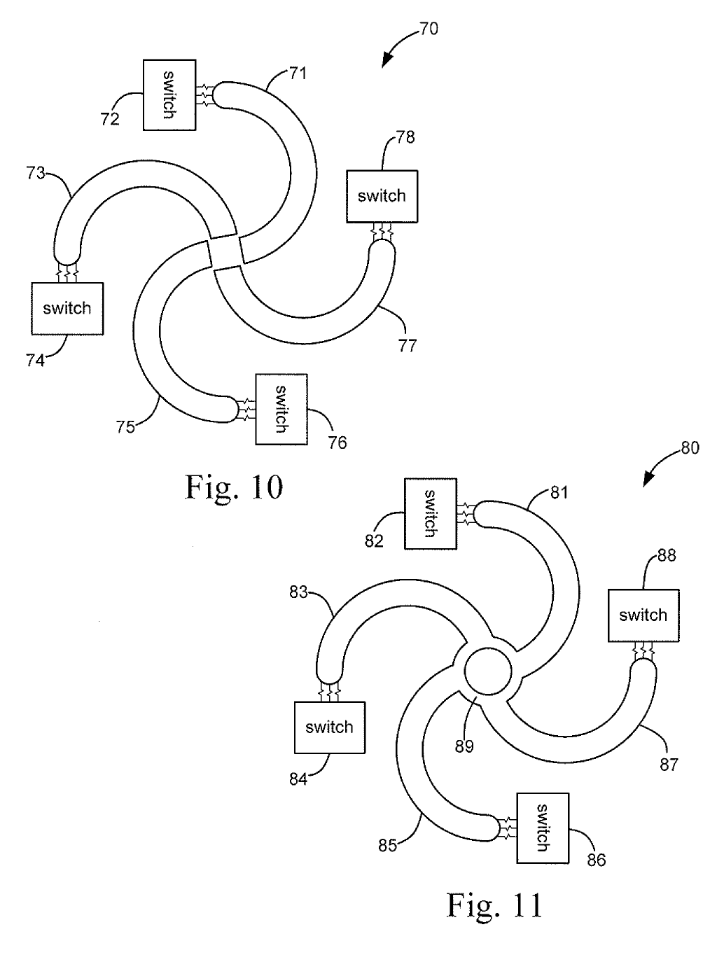

And FIGS. 10 and 11 show two additional exemplary embodiments of the compact accelerator, generally indicated at reference character 70 in FIG. 10, and reference character 80 in FIG. 11, each having Blumlein modules with non-linear strip-shaped configurations. In this case, the non-linear strip-shaped configuration is shown as a curvilinear or serpentine form. In FIG. 10, the accelerator 70 comprises four modules 71, 73, 75, and 77, shown perimetrically surrounding and extending towards a central region. Each module 71, 73, 75, and 77, is connected to an associated switch, 72, 74, 76, and 78, respectively. As can be seen from this arrangement, the direct radial distance between the first and second ends of each module is less than the total length of the non-linear module, which enables compactness of the accelerator while increasing the electrical transmission path. FIG. 11 shows a similar arrangement as in FIG. 10, with the accelerator 80 having four modules 81, 83, 85, and 87, shown perimetrically surrounding and extending towards a central region. Each module 81, 83, 85, and 87, is connected to an associated switch, 82, 84, 86, and 88, respectively. Furthermore, the radially inner ends, i.e. the second ends, of the modules are connected to each other by means of a ring electrode 89, providing the advantages discussed in FIG. 8.

### B. Sequentially Pulsed Traveling Wave Acceleration Mode

An Induction Linear Accelerator (LIAs), in the quiescent state is shorted along its entire length. Thus, the acceleration of a charged particle relies on the ability of the structure to create a transient electric field gradient and isolate a sequential series of applied acceleration pulse from the adjoining pulse-forming lines. In prior art LIAs, this method is implemented by causing the pulseforming lines to appear as a series of stacked voltage sources from the interior of the structure for a transient time, when preferably, the charge particle beam is present. Typical means for creating this acceleration gradient and providing the required isolation is through the use of magnetic cores within the accelerator and use of the transit time of the pulse-forming lines themselves. The latter includes the added length resulting from any connecting cables. After the acceleration transient has occurred, because of the saturation of the magnetic cores, the system once again appears as a short circuit along its length. The disadvantage of such prior art system is that the acceleration gradient is quite low (˜0.2-0.5 MV/m) due to the limited spatial extent of the acceleration region and magnetic material is expensive and bulky. Furthermore, even the best magnetic materials cannot respond to a fast pulse without severe loss of electrical energy. Thus if a core is required, to build a high gradient accelerator of this type can be impractical at best, and not technically feasible at worst.

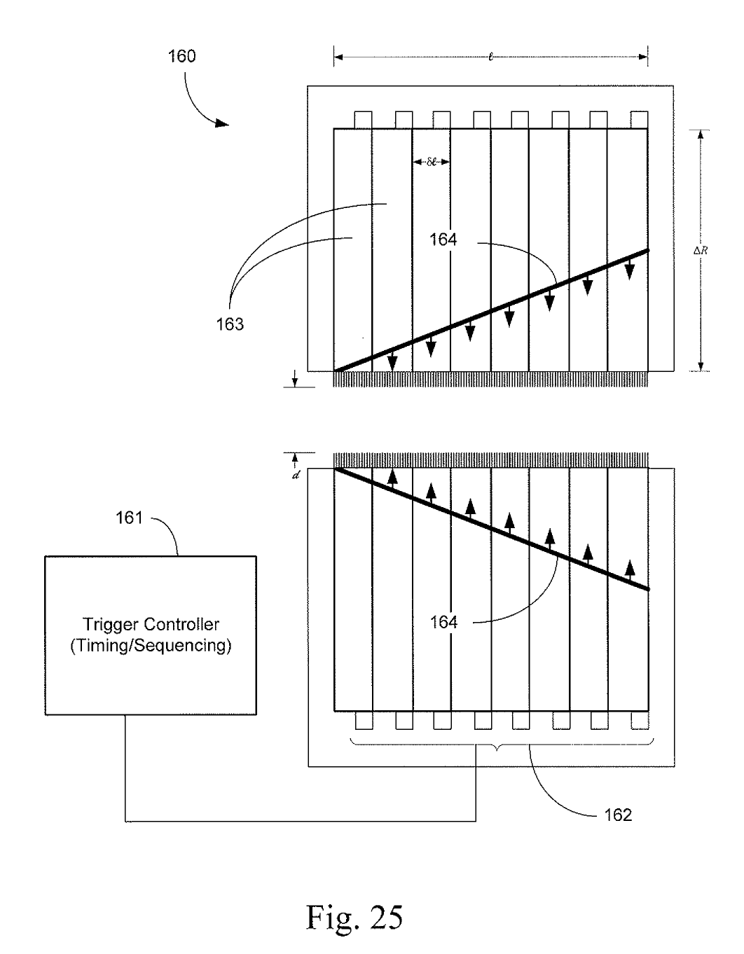

FIG. 25 shows a schematic view of the sequentially pulsed traveling wave accelerator of the present invention, generally indicated at reference character 160 having a length l. Each of the transmission lines of the accelerator is shown having a length ΔR and a width δl, and the beam tube has a diameter d surrounding the acceleration axis. A trigger controller 161 is provided for triggering a set of switches 162, with each switch capable of exciting a single transmission line and a corresponding short axial length δl of the beam tube wall with an acceleration pulse having electrical length (i.e. pulse width) τ. In particular, the trigger controller 161 is capable of sequentially triggering the switches to produce a propagating wavefront 164 through the triggered transmission lines and toward the beam tube. As the propagating wavefronts in the triggered transmission lines reach the beam tube, a traveling axial electric field i.e. a “traveling wave” is produced in and propagated along the beam tube in synchronism with an axially traversing pulsed beam of charged particles to serially impart energy to the particles. The trigger controller 161 may trigger each of the switches individually so that an acceleration pulse corresponding to the excited line is produced along an axial length δl of the beam tube wall; and also sequentially switch adjacent transmission lines individually so that the physical axial length of the traveling wave acceleration field is also δl.

Alternatively, the trigger controller 161 is capable of simultaneously switching at least two adjacent transmission lines which form a block, so that an acceleration pulse corresponding to the block is produced along an axial length nδl of the beam tube wall, where n is the number of adjacent excited lines at any instant of time, with n≧1. Moreover, the trigger controller 161 is capable of sequentially switching adjacent blocks, so that the physical axial length of the traveling wave acceleration field is also nδl. In this manner, a large acceleration “bucket” is formed to capture the full length of the particle bunch for acceleration. This is especially useful in the case of short pulse dielectric wall accelerators where the spatial width, i.e. axial length, δl of the traveling wave produced by triggering individual transmission lines is shorter than or comparable to the compressed bunch length of the charged particles. FIG. 29 illustrates the sequential triggering of block comprising two adjacent transmission lines such that the traveling wave has an axial length 2δl.

It is appreciated that in the case of either single line sequential triggering or block triggering of multiple adjacent lines, not all pulse forming lines or blocks are required to be triggered in order to operate the accelerator. In particular, depending on application requirements, some of the pulse-forming lines may not be triggered, such that acceleration gradients are produced only along certain segments of the acceleration axis, and the total energy of the system may be controlled. In such case, preferably the downstream lines and/or blocks are left unswitched, while the upstream lines and/or blocks are utilized. Furthermore, it is also appreciated that sequential triggering of lines and/or blocks may not require all lines and/or blocks between a first triggered line or block and a last triggered line or block, to be switched. For example, only even number pulse forming lines may be utilized.

Some example dimensions for illustration purposes: d=8 cm, τ=several nanoseconds (e.g. 1-5 nanoseconds for proton acceleration, 100 picoseconds to few nanoseconds for electron acceleration), v=c/2 where c=speed of light. It is appreciated, however, that the present invention is scalable to virtually any dimension. Preferably, the diameter d and length l of the beam tube satisfy the criteria l>4d, so as to reduce fringe fields at the input and output ends of the dielectric beam tube. Furthermore, the beam tube preferably satisfies the criteria: γτv>d/0.6, where v is the velocity of the wave on the beam tube wall, d is the diameter of the beam tube, τ is the pulse width where

$$τ = \frac{2 Δ R \sqrt{{μ}_{r} {ɛ}_{r}}}{c} ,$$

and γ is the Lorentz factor where

$$γ = \frac{1}{\sqrt{1 - \frac{{v}^{2}}{{c}^{2}}}} .$$

It is notable that ΔR is the length of the pulse-forming line, μᵣ is the relative permeability (usually =1), and εᵣ is the relative permitivity.) In this manner, the pulsed high gradient produced along the acceleration axis is at least about 30 MeV per meter and up to about 150 MeV per meter.

Unlike most accelerator systems of this type which require a core to create the acceleration gradient, the accelerator system of the present invention operates without a core because if the criteria nδl<l is satisfied, then the electrical activation of the beam tube occurs along a small section of the beam tube at a given time is kept from shorting out. By not using a core, the present invention avoids the various problems associated with the use of a core, such as the limitation of acceleration since the achievable voltage is limited by ΔB, where Vt=AΔB, where A is cross-sectional area of core. Use of a core also operates to limit repetition rate of the accelerator because a pulse power source is needed to reset the core. The acceleration pulsed in a given nδl is isolated from the conductive housing due to the transient isolation properties of the un-energized transmission lines neighboring the given axial segment. It is appreciated that a parasitic wave arises from incomplete transient isolation properties of the un-energized transmission lines since some of the switch current is shunted to the unenergized transmission lines. This occurs of course without magnetic core isolation to prevent this shunt from flowing. Under certain conditions, the parasitic wave may be used advantageously, such as illustrated in the following example. In a configuration of an open circuited Blumlein stack consisting of asymmetric strip Blumleins where only the fast/high impedance (low dielectric constant) line is switched, the parasitic wave generated in the un-energized transmission lines will generate a higher voltage on the un-energized lines boosting its voltage over the initial charged state while boosting the voltage on the slow line by a lesser amount. This is because the two lines appear in series as a voltage divider subjected to the same injected current. The wave appearing at the accelerator wall is now boosted to a larger value than initially charged, making a higher acceleration gradient achievable.

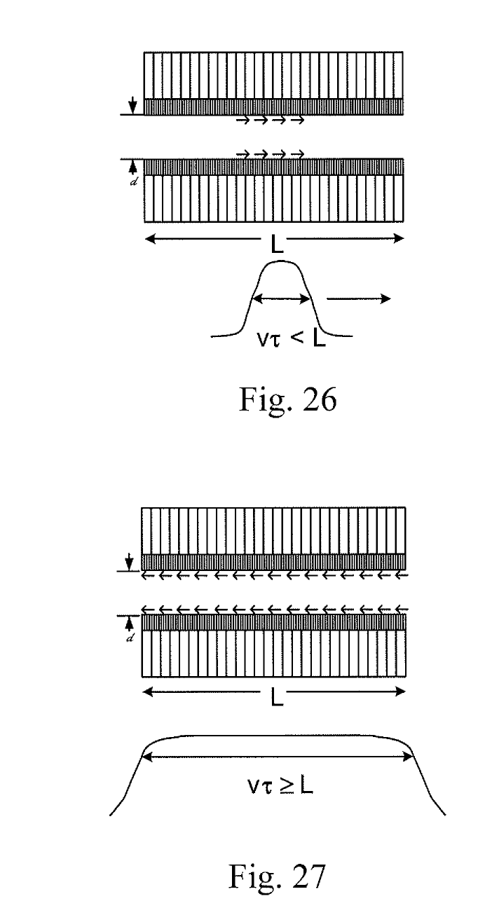

FIGS. 26 and 27 illustrate the difference in the gradient generated in the beam tube of length L. FIG. 26 shows the single pulse traveling wave having a width vτ less than the length L. In contrast, FIG. 27 shows a typical operation of stacked Blumlein modules where all the transmission lines are simultaneously triggered to produce a gradient across the entire length L of the accelerator. In this case, vτ is greater than or equal to length L.

### C. Charged Particle Generator: Integrated Pulsed Ion Source and Injector

FIG. 13 shows an exemplary embodiment of a charged particle generator 110 of the present invention, having an ion source, such as a pulsed ion source 112, and an injector 113 integrated into a single unit. In order to produce an intense pulsed ion beam, modulation of the extracted beam and subsequent bunching is required. First, the particle generator operates to create an intense pulsed ion beam by using a pulsed ion source 112 using a surface flashover discharge to produces a very dense plasma. Estimates of the plasma density are in excess of 7 atmospheres, and such discharges are prompt so as to allow creation of extremely short pulses. Conventional ion sources create a plasma discharge from a low pressure gas within a volume. From this volume, ions are extracted and collimated for acceleration into an accelerator. These systems are generally limited to extracted current densities of below 0.25 A/cm2. This low current density is partially due to the intensity of the plasma discharge at the extraction interface.

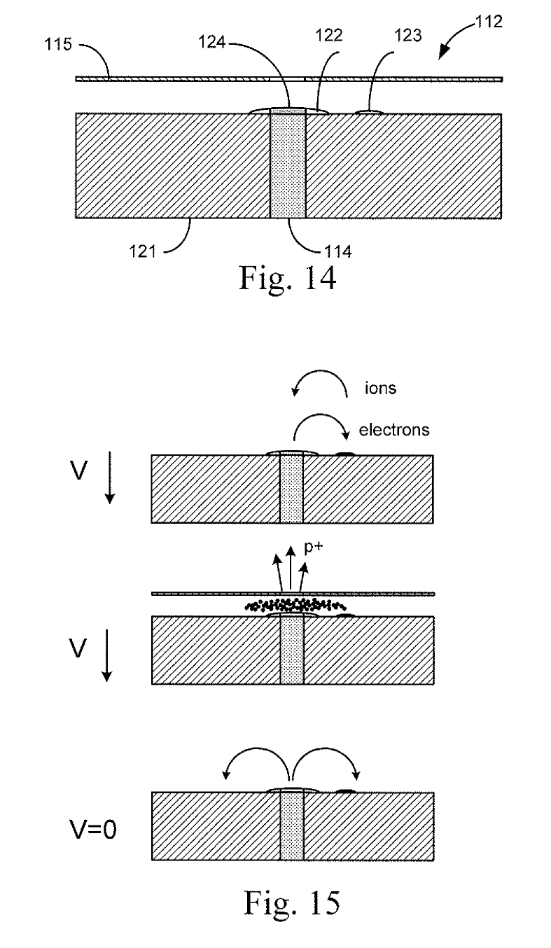

The pulsed ion source of the present invention has at least two electrodes which are bridged with an insulator. The gas species of interest is either dissolved within the metal electrodes or in a solid form between two electrodes. This geometry causes the spark created over the insulator to receive that substance into the discharge and become ionized for extraction into a beam. Preferably the at least two electrodes are bridged with an insulating, semi-insulating, or semi-conductive material by which a spark discharge is formed between these two electrodes. The material containing the desired ion species in atomic or molecular form in or in the vicinity of the electrodes. Preferably the material containing the desired ion species is an isotope of hydrogen, e.g. H2, or carbon. Furthermore, preferably at least one of the electrodes is semi-porous and a reservoir containing the desired ion species in atomic or molecular form is beneath that electrode. FIGS. 14 and 15 shows an exemplary embodiment of the pulsed ion source, generally indicated at reference character 112. A ceramic 121 is shown having a cathode 124 and an anode 123 on a surface of the ceramic. The cathode is shown surrounding a palladium centerpiece 124 which caps an H2 reservoir 114 below it. It is appreciated that the cathode and anode may be reversed. And an aperture plate, i.e. gated electrode 115 is positioned with the aperture aligned with the palladium top hat 124.

As shown in FIG. 15, high voltage is applied between the cathode and anode electrode to produce electron emission. As these electrodes are in near vacuum conditions initially, at a sufficiently high voltage, electrons are field emitted from the cathode. These electrons traverse the space to the anode and upon impacting the anode cause localized heating. This heating releases molecules that are subsequently impacted by the electrons, causing them to become ionized. These molecules may or may not be of the desired species. The ionized gas molecules (ions) accelerate back to the cathode and impact, in this case, a Pd Top Hat and cause heating. Pd has the property, when heated, will allow gas, most notably hydrogen, to permeate through the material. Thus, as the heating by the ions is sufficient to cause the hydrogen gas to leak locally into the volume, those leaked molecules are ionized by the electrons and form a plasma. And as the plasma builds up to sufficient density, a self-sustaining arc forms. Thus, a pulsed negatively charged electrode placed on the opposite of the aperture plate can be used to extract the ions and inject them into the accelerator. In the absence of an extractor electrode, an electric field of the proper polarity can be likewise used to extract the ions. And upon cessation of the arc, the gas deionizes. If the electrodes are made of a gettering material, the gas is absorbed into the metal electrodes to be subsequently used for the next cycle. Gas which is not reabsorbed is pumped out by the vacuum system. The advantage of this type of source is that the gas load on the vacuum system is minimized in pulsed applications.

Charged particle extraction, focusing and transport from an ion source, such as the pulsed ion source 112, to the input of a linear accelerator is provided by an integrated injector section 113, shown in FIG. 13. In particular, the injector section 113 of the charged particle generator serves to also transversely focus the charged-ion beam onto the target, which can be either a patient in a charged-particle therapy facility or a target for isotope generation or any other appropriate target for the charge-particle beam. Furthermore, the integrated injector of the present invention enables the charged particle generator to use only electric focusing fields for transporting the beam and focusing on the patient. There are no magnets in the system. The system can deliver a wide range of beam currents, energies and spot sizes independently.

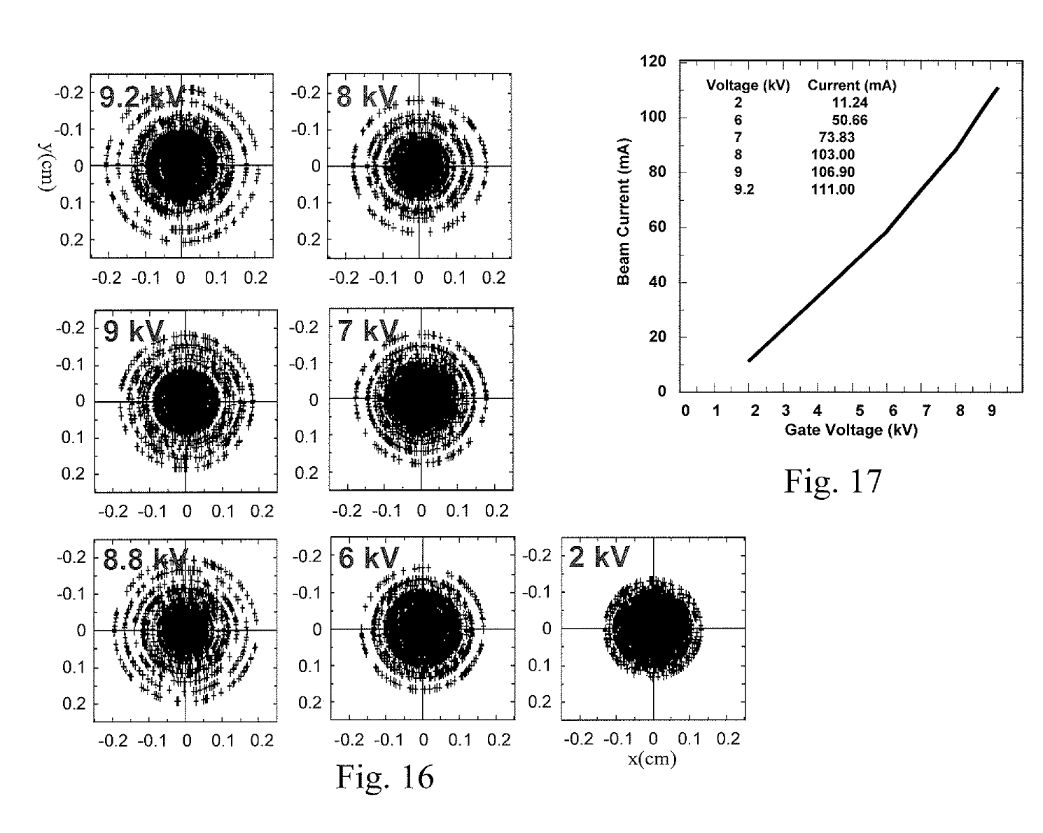

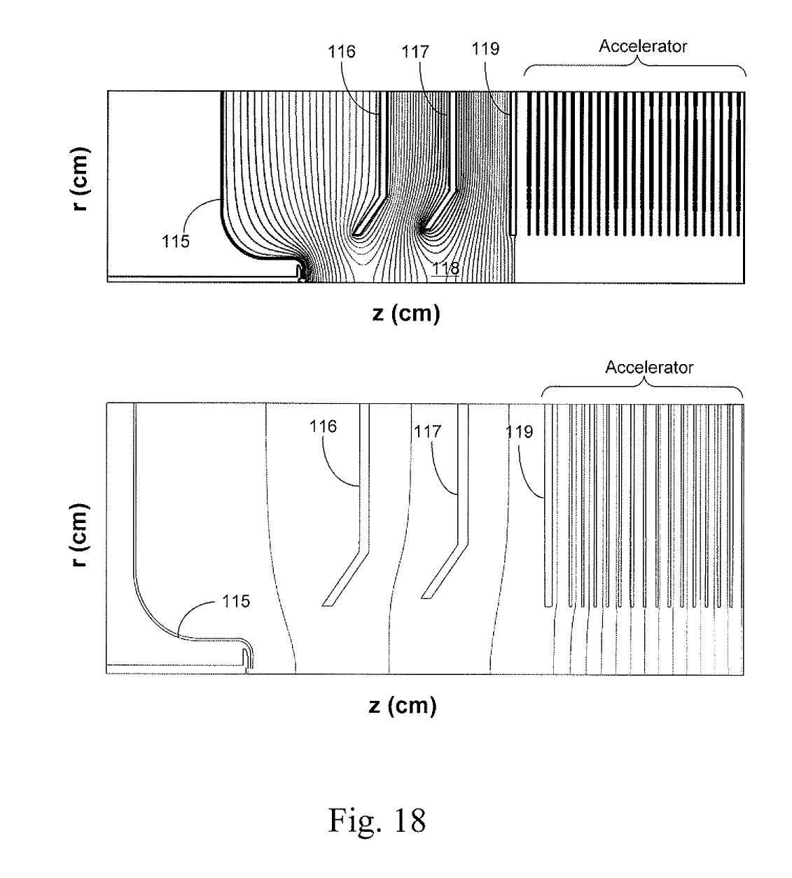

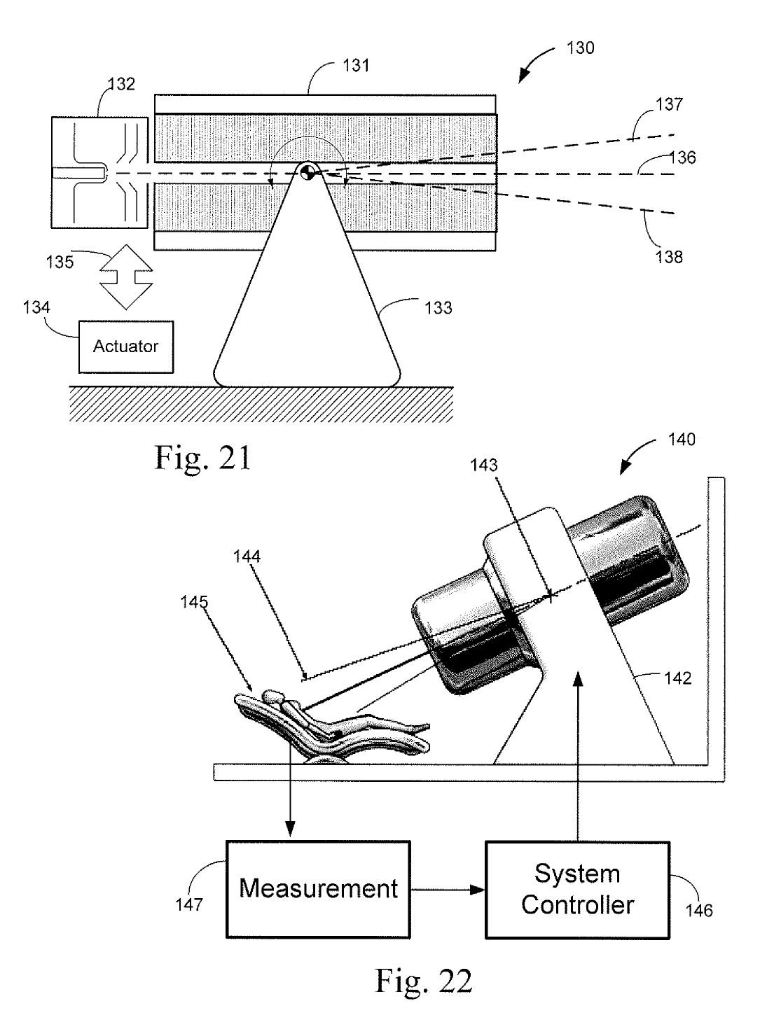

FIG. 13 shows a schematic arrangement of the injector 113 in relation to the pulsed ion source 112, and FIG. 21 shows a schematic of the combined charged particle generator 132 integrated with a linear accelerator 131. The entire compact high-gradient accelerator's beam extraction, transport and focus are controlled by the injector, preferably comprising a gate electrode 115, an extraction electrode 116, a focus electrode 117, and a grid electrode 119, which are located between the charge particle source and the high-gradient accelerator. It is notable, however, that the minimum transport system should consist of an extraction electrode, a focusing electrode and the grid electrode. And more than one electrode for each function can be used if they are needed. All the electrodes can also be shaped to optimize the performance of the system, as shown in FIG. 18. The gate electrode 115 with a fast pulsing voltage is used to turn the charged particle beam on and off within a few nanoseconds. The simulated extracted beam current as a function of the gate voltage in a high-gradient accelerator designed for proton therapy is presented in FIG. 17, and the final beam spots for various gate voltages are presented in FIG. 16. In simulations performed by the inventors, the nominal gate electrode's voltage is −9 kV, the extraction electrode is at −980 kV, the focus electrode is at −90 kV, the grid electrode is at −980 kV, and the high-gradient accelerator is acceleration gradient is 100 MV/m. Since FIG. 16 shows that the final spot size is not sensitive to the gate electrode's voltage setting, the gate voltage provides an easy knob to turn on/off the beam current as indicated by FIG. 17.

The high-gradient accelerator system's injector uses a gate electrode and an extraction electrode to extract and catch the space charge dominated beam, which current is determined by the voltage on the extraction electrode. The accelerator system uses a set of at least one focus electrodes 117 to focus the beam onto the target. The potential contour plots shown in FIG. 18, illustrate how the extraction electrodes and the focus electrodes function. The minimum focusing/transport system, i.e., one extraction electrode and one focus electrode, is used in this case. The voltages on the extraction electrode, the focus electrode and the grid electrode at the high-gradient accelerator entrance are −980 kV, −90 kV and −980 kV. FIG. 18 shows that the shaped extraction electrode voltage sets the gap voltage between the gate electrode and the extraction electrode. FIG. 18 also shows that the voltages on the shaped extraction electrode, the shaped focusing electrode and the grid electrodes create an electrostatic focusing-defocusing-focusing region, i.e., an Einzel lens, which provides a strong net focusing force on the charge particle beam.

Although using Einzel lens to focus beam is not new, the accelerator system of the present invention is totally free of focusing magnets. Furthermore, the present invention also combines Einzel lens with other electrodes to allow the beam spot size at the target tunable and independent of the beam's current and energy. At the exit of the injector or the entrance of our high-gradient accelerator, there is the grid electrode 119. The extraction electrode and the grid electrode will be set at the same voltage. By having the grid electrode's voltage the same as the extraction electrode's voltage, the energy of the beam injected into the accelerator will stay the same regardless of the voltage setting on the shaped focus electrode. Hence, changing the voltage on the shaped focus electrode will only modify the strength of the Einzel lens but not the beam energy. Since the beam current is determined by the extraction electrode's voltage, the final spot can be tuned freely by adjusting the shaped focus electrode's voltage, which is independent of the beam current and energy. In such a system, it is also appreciated that additional focusing results from a proper gradient (i.e. dE_{z}/dz) in the axial electric field and additionally as a result in the time rate of change of the electric field (i.e. dE/dt at z=z₀).

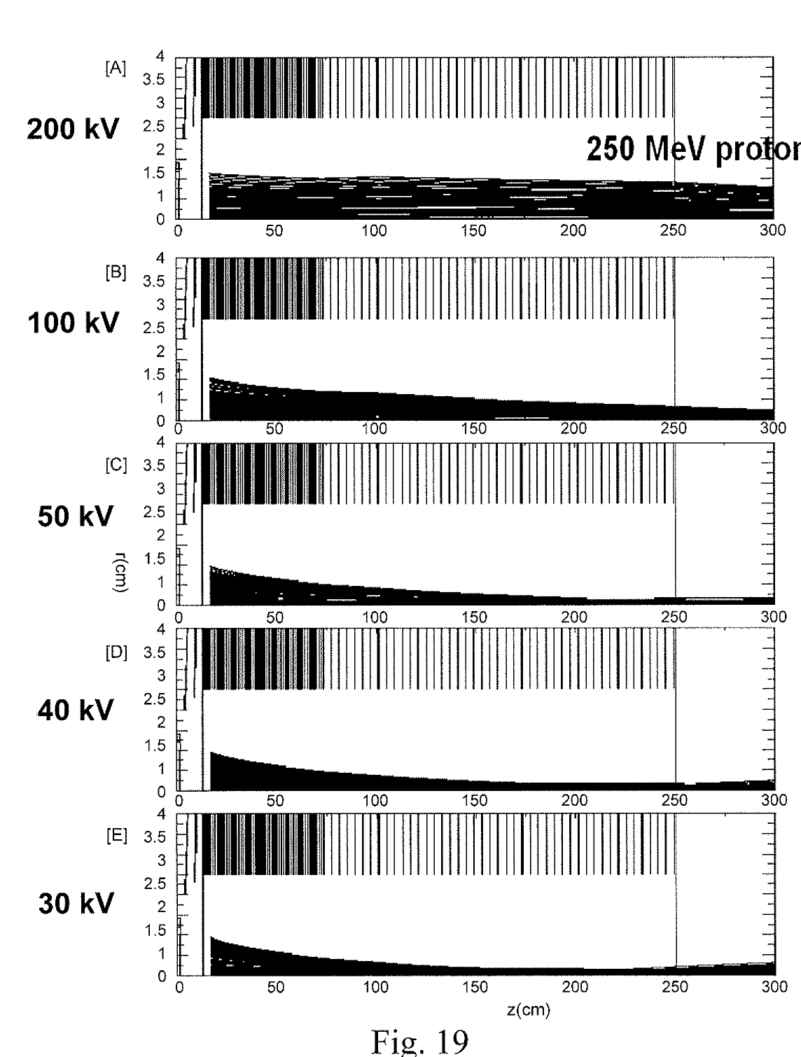

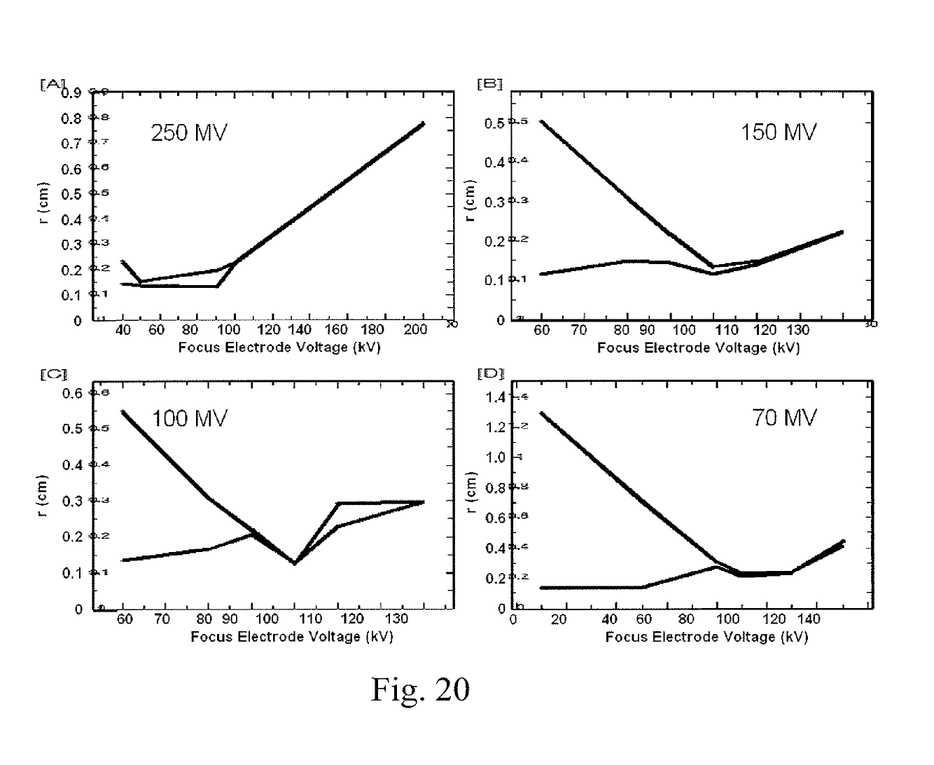

Simulated beam envelopes for beam transport through a magnet-free 250-MeV proton high-gradient accelerator with various focus electrode voltage setting is presented in FIG. 19. With their corresponding focus electrode voltages given at the left, these plots clearly show that the spot size of the 250-MeV proton beam on the target can easily be tuned by adjusting the focus electrode voltage. And plots of spot sizes versus the focus electrode voltage for various proton beam energies are shown in FIG. 20. Two curves are plotted for each proton energy. The upper curves present the edge radii of the beam, and the lower curves present the core radii. These plots show that a wide range of spot sizes (2 mm-2 cm diameter) can be obtained for the 70-250 MeV, 100-mA proton beam by adjusting the focus electrode voltage on a high-gradient proton therapy accelerator with an accelerating gradient of 100-MV.

The compact high-gradient accelerator system employing such an integrated charged particle generator can deliver a wide range of beam currents, energies and spot sizes independently. The entire accelerator's beam extraction, transport and focus are controlled by a gate electrode, a shaped extraction electrode, a shaped focus electrode and a grid electrode, which locate between the charge particle source and the high-gradient accelerator. The extraction electrode and the grid electrode have the same voltage setting. The shaped focus electrode between them is set at a lower voltage, which forms an Einzel lens and provides the tuning knob for the spot size. While the minimum transport system consists of an extraction electrode, a focusing electrode and the grid electrode, more Einzel lens with alternating voltages can be added between the shaped focus electrode and the grid electrode if a system needs really strong focusing force.

### D. Beam Transport System and Strategy

Another aspect of the present invention utilizes a beam transport system and method which controls the ramping in time of a voltage difference between two serially arranged electrodes to longitudinally compress the charged particle bunch prior to injection into the acceleration stage. Additional electrodes may be provided to performing transverse focusing (e.g. in an Einzel lens arrangement) and to control final beam spot size as previously discussed. In addition, the beam transport method and system may employ simultaneous switching of multiple adjacent pulse-forming lines to produce an acceleration electric field having a physical size that is greater than the bunch length. And furthermore, the beam transport system and method may additionally control the timing of switch triggering as the means for performing alternating phase focusing in the acceleration stage of a sequentially pulsed traveling wave accelerator architecture.

As discussed in Section B. for the sequentially pulsed traveling wave accelerator, coreless short pulse dielectric wall accelerators can produce a very high gradient and are therefore highly desirable. However, there are some disadvantages of this architecture. First, a parasitic energy drain exists from the pulse-forming lines that can lead to a distortion of the pulse shape so that the accelerating waveform has almost no flattop, as discussed in the Background section. And in order to allow the dielectric wall to have a high breakdown strength, the second disadvantage and constraint is that the pulsewidth must be short, typically on the order of a few nanoseconds. Because the acceleration waveform lacks a flattop, it is difficult to maintain a low energy spread across the bunch unless the charge bunch's bunch length is much shorter than the waveform's pulsewidth. However, the charged particle bunch that is extracted from the charged particle generator, (e.g. a pulsed ion source), is usually comparable lengthwise to the pulsewidth of the acceleration waveform E_{z}(t). In other words, for a given axial segment experiencing an acceleration pulse, the time it takes for all particles of an extracted charged particle bunch having a given bunch length and respective particle velocities to enter the axial segment and experience the acceleration pulse, is comparable to the duration of the pulse. Therefore, the charged particle bunch needs to be compressed longitudinally before being injected into the short pulse dielectric wall accelerator. Preferably, the necessary longitudinal compression is roughly by a factor of ten. Moreover, in order to reduce the energy spread across the bunch, the entire particle bunch must preferably coincide with the energy (E_{z}) waveform along a narrow segment thereof in the acceleration stage, either along the rising edge or falling edge, and preferably be positioned close to the peak of the accelerating waveform in order to accelerate the charged particle bunch with the maximum acceleration gradient possible.

The present invention utilizes the injector stage between the charged particle source and the accelerator stage to perform longitudinal compression of the charged particle bunch prior to injecting into the acceleration stage. In particular, two electrodes serially arranged along the acceleration axis are preferably used to perform the necessary longitudinal compression by ramping in time the voltage difference between the two electrodes so that upstream particles of the bunch have a greater kinetic energy (momentum) than downstream particles, to cause longitudinal compression of the bunch. It is appreciated that the ramping of the voltage difference may be either in an upward slope or downward slope, depending on the type (positive or negative) of charged particles to be accelerated and whether the longitudinal compression is effected by means of either accelerating the bunch or decelerating the bunch. And it is further appreciated that a voltage controller, such as known in the art, may be used to implement the ramping in time operation, such as by controlling the slope of the ramping in time operation.

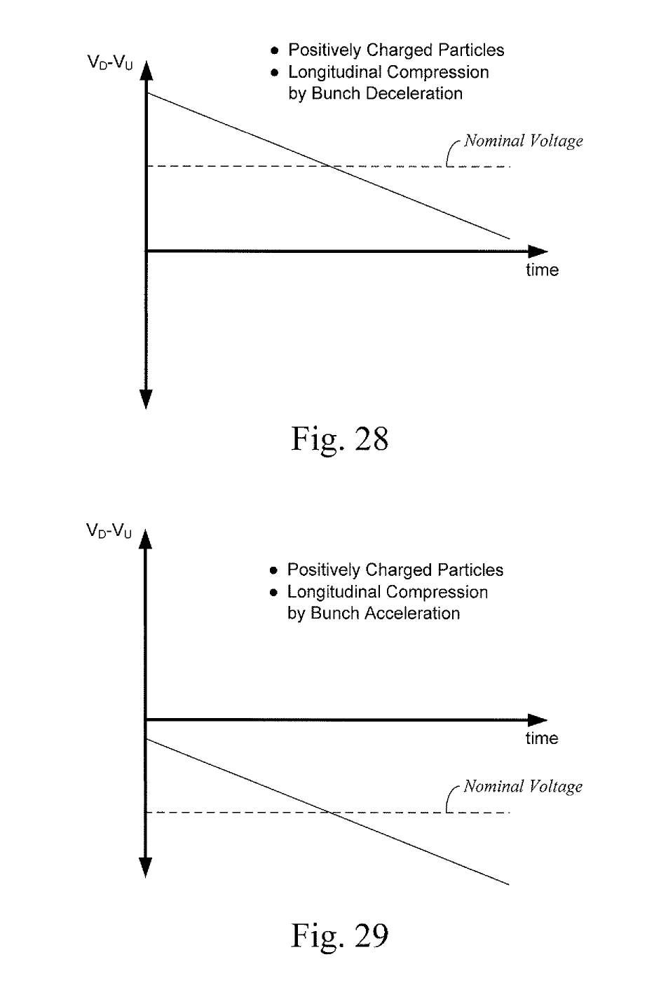

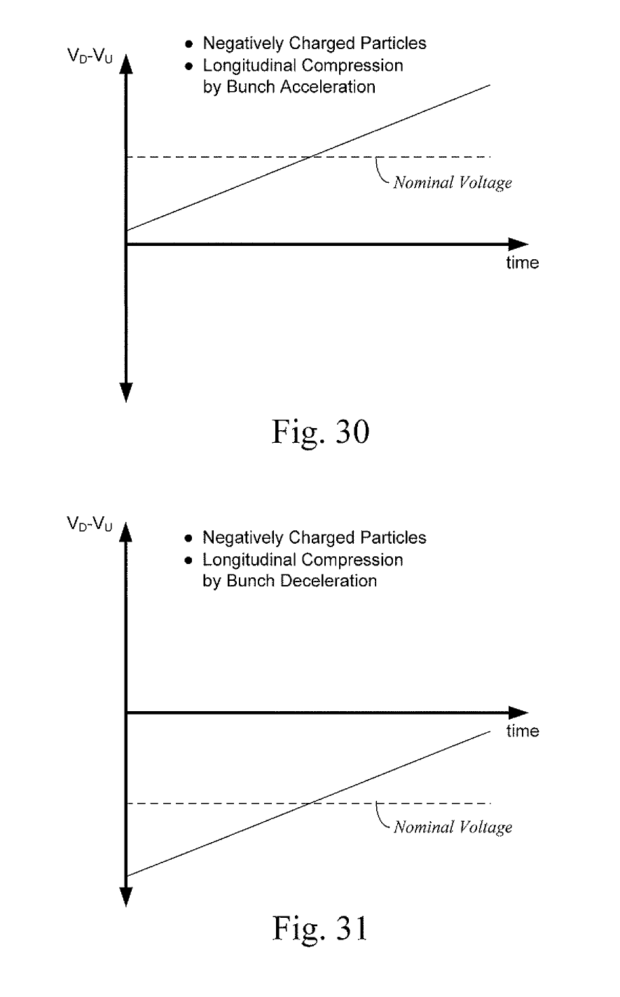

The type of ramping in time of the voltage difference between the two electrodes will depend on whether the particles being longitudinally compressed are positively charged or negatively charged. For positively charged particles, positive polarity electrodes would be used to decelerate the particles, while negative polarity electrodes would be used to accelerate the particles. FIGS. 28 and 29 show two graphs illustrating the ramping down in time of the voltage difference V_{D}−V_{U} for positively charged particles to cause longitudinal compression of a charged particle bunch, where V_{D} is the voltage of the downstream electrode and V_{U} is the voltage of the upstream electrode. In particular, the graph of FIG. 28 shows the case of longitudinal compression by means of bunch deceleration, and the graph of FIG. 29 shows the case of longitudinal compression by means of bunch acceleration. And for negatively charged particles, positive polarity electrodes would be used to accelerate the particles, while negative polarity electrodes would be used to decelerate the particles. And FIGS. 30 and 31 show two graphs illustrating the ramping up in time of the voltage difference V_{D}−V_{U} for negatively charged particles to cause longitudinal compression of a charged particle bunch. In particular, the graph of FIG. 30 is for the case of longitudinal compression by means of bunch deceleration, and the graph of FIG. 29 is for the case of longitudinal compression by means of bunch acceleration.

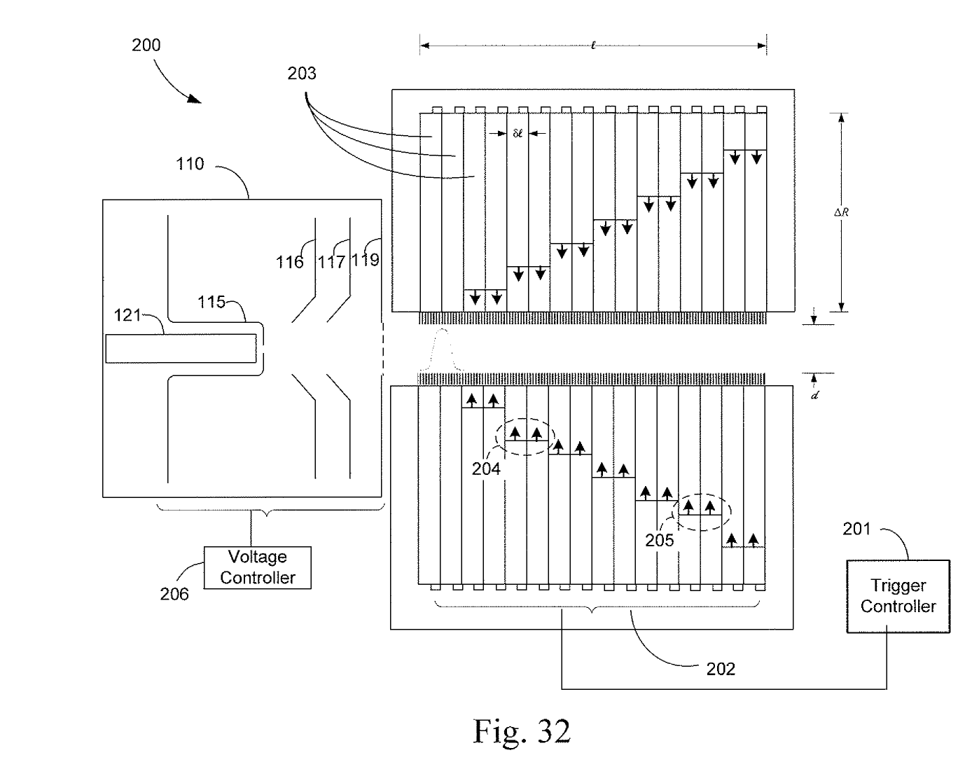

As shown in FIG. 32, various electrodes of a lens stack may be used as the pair of electrodes which perform longitudinal compression by voltage difference ramping in time. In particular, FIG. 32 shows a linear accelerator system 200, in which the gate electrode 115 and the extraction electrode 116, for example, may be chosen to perform the longitudinal compression. A voltage controller 206 shown operably connected to the electrodes is used to perform the time varying ramping of the electric field in the injector stage. It is appreciated, however, that other pairs of electrodes (not necessarily the gate and extraction electrodes) may used for the longitudinal compression. For example, in the alternative, the extraction electrode 116 and the focus electrode 117 shown in FIG. 32 may perform the ramping modulation in time of the electric field to cause longitudinal compression.

In addition to the ramping electrodes for longitudinal compression, at least one transverse focusing electrode or electrodes may also be provided and serially arranged along the acceleration axis to perform transverse focusing of the bunch prior to be injected into the acceleration stage. As shown in FIG. 32, the same voltage controller 206 used to control the ramping in time operation may also be used to control the transverse focusing electrodes and perform the transverse focusing. In the alternative, a separate dedicated voltage controller (not shown) may be used for controlling the transverse focusing. In either case, the at least one transverse focusing electrode(s) may be used to control the final beam spot size that is produced on a target independently from the charge and energy of the bunch. Furthermore, the transverse focusing electrodes may be arranged either together with one or more of the ramping electrodes or independent of the ramping electrodes, to perform the transverse focusing. In the first case, for example, the two ramping electrodes and a third electrode may be arranged as a single focusing lens stack, e.g. an Einzel lens. In this case, the voltage of the third electrode may be set at the same voltage as the first electrode, or separately modulated relative to the voltage on electrode 117 to affect the magnitude of transverse focusing. For example, in FIG. 32, the Einzel lens stack comprising electrodes 116, 117, and 119 may be used for both longitudinal compression as well as radial focusing, with the voltage controller 206 ramping in time the voltage difference between electrodes 116 and 117, while the voltage on electrode 119 is held to the same potential as electrode 116. And in the second case where transverse focusing is achieved independent of the longitudinal compression by ramping in time, one exemplary embodiment may comprise two electrodes dedicated for performing longitudinal compression while three different electrodes are separated dedicated for performing transverse focusing.

The second beam transport strategy involves a plurality of pulse-forming lines used in the sequentially activated traveling wave accelerator architecture and operation previously discussed in Section B. herein. In particular, the transport strategy involves simultaneous switching multiple adjacent pulse-forming lines to produce an acceleration electric field having a physical size that is greater than the bunch length. While the capture of a short charge particle bunch with a traveling acceleration wave has been done, those acceleration field's wavelengths are much longer than the physical length of the injected bunch of charged particles. In the short pulse dielectric wall accelerator architecture, the spatial width of the traveling wave from individual transmission lines is shorter than or comparable to the compressed charged bunch length. In order to catch the entire compressed bunch with the traveling acceleration wave calls for a large acceleration wave bucket. To achieve a larger wave bucket, the switches of several transmission lines' switches' are turned on simultaneously. This is illustrated in FIG. 32 showing a sequentially pulsed traveling wave accelerator architecture having multiple pulse forming lines 203, with a set of switches 202 producing propagating wave fronts (e.g. 204 and 205) through the respective lines when triggered by trigger controller 201. The accelerator system is also shown having a pulsed ion source 121 which together with the injector section form the charged particle generator 110 as previously discussed herein. With respect to the transmission lines, FIG. 32 shows in particular two adjacent transmission lines forming a block, with the blocks being triggered sequentially by trigger controller 201. In this manner, the spatial width (axial length) of the electric field will be defined by line widths δl, and by the block widths nδl where n is the number of lines per block.

The third beam transport strategy involves alternative phase focusing by controlling the timing of switch triggering so that the energy pulse intercepts the axially traveling charged particle bunch either on the rising edge of the waveform, or on the falling edge of the waveform, to manipulate and control the bunch (transversely focusing-defocusing/longitudinally compressing/decompressing) to achieve a desired final spot size of the target. The alternating phase focusing, i.e. the timing of the switch triggering (whether to make it longitudinal focusing or defocusing, and transverse focusing/defocusing), will be a function of the injected beam size from the injector (Einzel lens stack) which is known, to achieve the final beam spot size. Depending on the bunch's initial length and its exact phase position with respect to the acceleration waveform, the bunch will be gently longitudinally compressed, or its bunch length will be maintained by having the longitudinal bunch expansion of the space charge forces balanced with the longitudinal bunch compression of the rising acceleration field. In FIG. 32, alternating phase focusing operation is shown by the non-uniform spacing of the propagating wavefronts through the transmission line blocks. In particular wavefront 204 is shown slightly delayed and therefore further spaced from the wavefront in the preceding block, while wavefront 205 is shown slightly advanced and thus closer to the wavefront in the preceding block. The alternating phase focusing is shown also controlled by the trigger controller 201.

The rapid variation of axial electric field with time in the pulse leads to large transverse electric fields that will transversely defocus the bunch on the rising edge of the waveform, and transversely focus it on the falling edge, as discussed in the Background section. To minimize the large transverse electric field and to maximize the acceleration field, the bunch is preferably injected into the accelerator near the crest of the acceleration energy (Ez(t)) waveform. In the case where the longitudinal compression at the injector stage produces a bunch that is still contracting when it enters the acceleration stage, the bunch is preferably injected into the acceleration stage to encounter the energy waveform along the rising edge near the crest. In contrast, in the case where the longitudinal compression at the injector stage produces a bunch that contracts too much such that it starts expanding again, the bunch is preferably injected into the acceleration stage to encounter the energy waveform along the trialing edge near the crest. In either case, with the bunch injected near the crest, the transverse defocusing forces of the rising acceleration fields are small. Proper setting of Einzel lenses in the injector may be chosen to accommodate these transverse defocus forces in the accelerator.

### E. Actuable Compact Accelerator System for Medical Therapy

FIG. 21 shows a schematic view of an exemplary actuable compact accelerator system 130 of the present invention having a charged particle generator 132 integrally mounted or otherwise located at an input end of a compact linear accelerator 131 to form a charged particle beam and to inject the beam into the compact accelerator along the acceleration axis. By integrating the charged particle generator to the acceleration in this manner, a relatively compact size with unit construction may be achieved capable of unitary actuation by an actuator mechanism 134, as indicated by arrow 135, and beams 136-138. In previous systems, because of their scale size, magnets were required to transport a beam from a remote location. In contrast, because the scale size is significantly reduced in the present invention, a beam such as a proton beam may be generated, controlled, and transported all in close proximity to the desired target location, and without the use of magnets. Such a compact system would be ideal for use in medical therapy accelerator applications, for example.

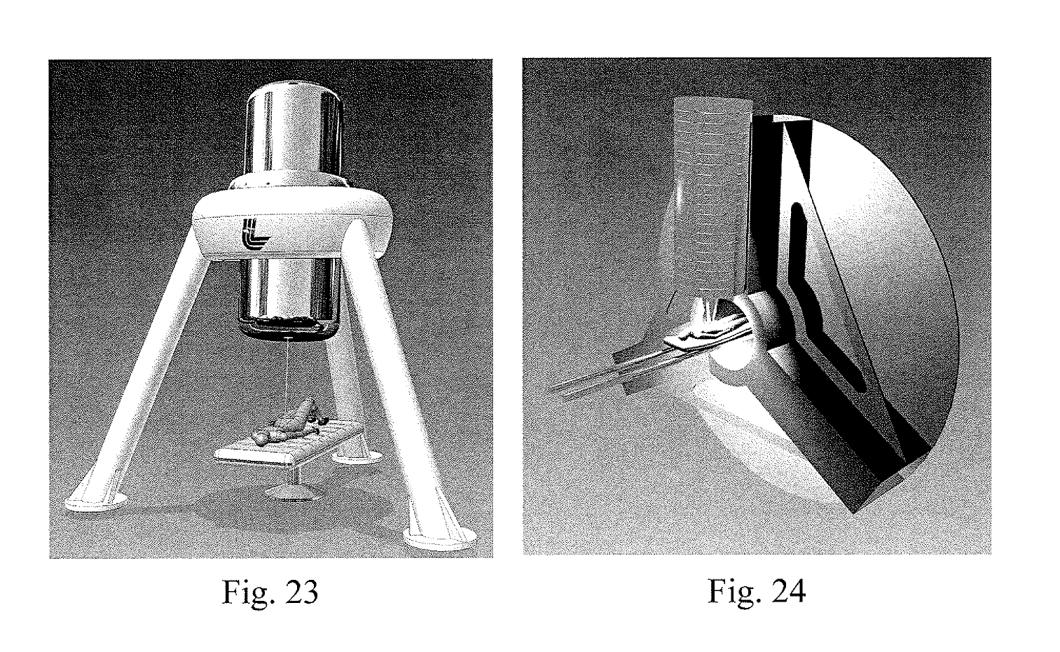

Such a unitary apparatus may be mounted on a support structure, generally shown at 133, which is configured to actuate the integrated particle generator-linear accelerator to directly control the position of a charged particle beam and beam spot created thereby. Various configurations for mounting the unitary combination of compact accelerator and charge particle source are shown in FIGS. 22-24, but is not limited to such. In particular, FIGS. 22-24 show exemplary embodiments of the present invention showing a combined compact accelerator/charged particle source mounted on various types of support structure, so as to be actuable for controlling beam pointing. The accelerator and charged particle source may be suspended and articulated from a fixed stand and directed to the patient (FIGS. 22 and 23). In FIG. 22, unitary actuation is possible by rotating the unit apparatus about the center of gravity indicated at 143. As shown in FIG. 22, the integrated compact generator-accelerator may be preferably pivotally actuated about its center of gravity to reduce the energy required to point the accelerated beam. It is appreciated, however, that other mounting configurations and support structures are possible within the scope of the present invention for actuating such a compact and unitary combination of compact accelerator and charged particle source.

It is appreciated that various accelerator architectures may be used for integration with the charged particle generator which enables the compact actuable structure. For example, accelerator architecture may employ two transmission lines in a Blumlein module construction previously described. Preferably the transmission lines are parallel plate transmission lines. Furthermore, the transmission lines preferably have a strip-shaped configuration as shown in FIGS. 1-12. Also, various types of high-voltage switches with fast (nanosecond) close times may be used, such as for example, SiC photoconductive switches, gas switches, or oil switches.

And various actuator mechanisms and system control methods known in the art may be used for controlling actuation and operation of the accelerator system. For example, simple ball screws, stepper motors, solenoids, electrically activated translators and/or pneumatics, etc. may be used to control accelerator beam positioning and motion. This allows programming of the beam path to be very similar if not identical to programming language universally used in CNC equipment. It is appreciated that the actuator mechanism functions to put the integrated particle generator-accelerator into mechanical action or motion so as to control the accelerated beam direction and beamspot position. In this regard, the system has at least one degree of rotational freedom (e.g. for pivoting about a center of mass), but preferably has six degrees of freedom (DOF) which is the set of independent displacement that specify completely the displaced or deformed position of the body or system, including three translations and three rotations, as known in the art. The translations represent the ability to move in each of three dimensions, while the rotations represent the ability to change angle around the three perpendicular axes.

Accuracy of the accelerated beam parameters can be controlled by an active locating, monitoring, and feedback positioning system (e.g. a monitor located on the patient 145) designed into the control and pointing system of the accelerator, as represented by measurement box 147 in FIG. 22. And a system controller 146 is shown controlling the accelerator system, which may be based on at least one of the following parameters of beam direction, beamspot position, beamspot size, dose, beam intensity, and beam energy. Depth is controlled relatively precisely by energy based on the Bragg peak. The system controller preferably also includes a feedforward system for monitoring and providing feedforward data on at least one of the parameters. And the beam created by the charged particle and accelerator may be configured to generate an oscillatory projection on the patient. Preferably, in one embodiment, the oscillatory projection is a circle with a continuously varying radius. In any case, the application of the beam may be actively controlled based on one or a combination of the following: position, dose, spot-size, beam intensity, beam energy.

While particular operational sequences, materials, temperatures, parameters, and particular embodiments have been described and or illustrated, such are not intended to be limiting. Modifications and changes may become apparent to those skilled in the art, and it is intended that the invention be limited only by the scope of the appended claims.

We claim:

1. A linear accelerator system comprising:
a charged particle source for producing a bunch of charged particles;
a linear accelerator for producing at least one acceleration gradient along an acceleration axis;
a lens stack having two electrodes serially arranged along the acceleration axis between the charged particle source and the linear accelerator; and
voltage controller means for ramping in time a voltage difference produced between the two electrodes so that upstream particles of the bunch have a greater kinetic energy than downstream particles so as to longitudinally compress the bunch of charged particles prior to being injected into the linear accelerator.

2. The linear accelerator system of claim 1,
wherein the lens stack further comprises at least one additional electrode(s) serially arranged along the acceleration axis between the charged particle source and the linear accelerator; and
further comprising voltage controller means for controlling the voltages of the at least one additional electrode(s) to control the transverse focusing of the bunch of charged particles prior to being injected into the linear accelerator and to thereby control a beam spot size independent of the current and energy of the bunch of charged particles.

3. The linear accelerator system of claim 1,
wherein said linear accelerator includes:
a dielectric wall beam tube surrounding an acceleration axis;
a plurality of pulse-forming lines transversely extending to and serially arranged along the dielectric wall beam tube, each pulse-forming line having a switch connectable to a high voltage potential for propagating at least one electrical wavefront(s) through the pulse-forming line independently from other pulse-forming lines to produce a short acceleration pulse adjacent a corresponding short axial length of the dielectric wall beam tube the acceleration axis; and
a trigger controller for sequentially activating said switches in groups of at least one switch(es) corresponding to a block of adjacent pulse-forming line(s) so that the groups of short acceleration pulses sequentially produced thereby form a traveling axial electric field that propagates along the acceleration axis in substantial synchronism with the injected bunch of charged particles to serially impart acceleration energy thereto.

4. The linear accelerator system of claim 3,
wherein said trigger controller is adapted to sequentially activate said switch groups so that said traveling axial electric field has an axial length that is greater than the injected bunch of charged particles.

5. The linear accelerator system of claim 3,
wherein said trigger controller is adapted to perform alternating phase focusing by controlling the activation timing of each of the switch groups relative to a crest of the E_{z}(t) energy waveform of the traveling axial electric field so that acceleration energy is imparted to the injected bunch of charged particles along either a predominantly rising edge or a predominantly falling edge of the E_{z}(t) energy waveform of the traveling axial electric field.

6. The linear accelerator system of claim 3,
wherein said trigger controller is adapted to time the activation of a first switch group so that acceleration energy is first imparted to the injected bunch of charged particles along the predominantly rising edge and near the crest of the E_{z} energy waveform of the traveling axial electric field.

7. The linear accelerator system of claim 1,
wherein said first electrode of the lens stack is an extraction electrode for extracting the bunch of charged particles from the charged particle source and injecting the bunch of charged particles into the linear accelerator.

8. A short pulse dielectric wall accelerator system comprising:
a pulsed ion source for producing a bunch of charged particles;
a dielectric wall beam tube surrounding an acceleration axis and having an inlet end and an outlet end;
a plurality of pulse-forming lines transversely connected to and serially arranged along the dielectric wall beam tube, each pulse-forming line having a switch connectable to a high voltage potential for propagating at least one electrical wavefront(s) through the pulse-forming line independently from other pulse-forming lines to produce a short acceleration pulse adjacent a corresponding short axial length of the dielectric wall beam tube;
a lens stack comprising two longitudinal compression electrodes, and at least one transverse focusing electrode(s), all of which are serially arranged along the acceleration axis between the pulsed ion source and the inlet end of the dielectric wall beam tube;
voltage controller means for ramping in time a voltage difference produced between the two longitudinal compression electrodes so that upstream particles of the bunch have a greater kinetic energy than downstream particles so as to longitudinally compress the bunch of charged particles prior to being injected into the linear accelerator, and for controlling the voltages of the transverse focusing electrode(s) to control the transverse focusing of the bunch of charged particles prior to being injected into the linear accelerator and to thereby control a beam spot size independent of the current and energy of the bunch of charged particles; and
a trigger controller for sequentially activating said switches in groups of at least one switch(es) corresponding to a block of adjacent pulse-forming line(s) so that the groups of short acceleration pulses sequentially produced by said switch groups form a traveling axial electric field that propagates along the acceleration axis in substantial synchronism with the injected bunch of charged particles to serially impart acceleration energy thereto.

9. The short pulse dielectric wall linear accelerator system of claim 8,
wherein said trigger controller is adapted to sequentially activate said switch groups so that said traveling axial electric field has an axial length that is greater than the injected bunch of charged particles.

10. The short pulse dielectric wall linear accelerator system of claim 8,
wherein said trigger controller is adapted to perform alternating phase focusing by controlling the activation timing of each of the switch groups relative to a crest of the E_{z}(t) energy waveform of the traveling axial electric field so that acceleration energy is imparted to the injected bunch of charged particles along either a predominantly rising edge or a predominantly falling edge of the E_{z}(t) energy waveform of the traveling axial electric field.

11. A beam transport method for longitudinally compressing a bunch of charged particles produced by a charged particle source, comprising:
providing two longitudinal compression electrodes and at least one transverse focusing electrode(s) serially arranged along the acceleration axis adjacent the charged particle source;
ramping in time a voltage difference produced between first and second electrodes so that upstream particles of the bunch have a greater kinetic energy than downstream particles so as to longitudinally compress the bunch of charged particles while in flight along the acceleration axis; and
controlling the voltages of the transverse focusing electrode(s) to control the transverse focusing of the bunch of charged particles while in flight along the acceleration axis.

12. A beam transport method for linear accelerators comprising:
providing a linear accelerator system comprising: a charged particle source; a linear accelerator for producing at least one acceleration gradient along an acceleration axis; and a lens stack comprising two electrodes which are serially arranged along the acceleration axis between the charged particle source and the linear accelerator;
producing a bunch of charged particles from said charged particle source;
extracting the bunch of charged particles into the lens stack;
ramping in time a voltage difference produced between the two electrodes so that upstream particles of the bunch have a greater kinetic energy than downstream particles so as to longitudinally compress the bunch of charged particles prior to being injected into the linear accelerator; and
injecting the longitudinally compressed bunch of charged particles into the linear accelerator.

13. The beam transport method of claim 12,
wherein the lens stack further comprises at least one additional electrode(s) serially arranged along the acceleration axis between the charged particle source and the linear accelerator; and
further comprising the step of controlling the voltages of the at least one additional electrode(s) to control the transverse focusing of the bunch of charged particles prior to being injected into the linear accelerator and to thereby control a beam spot size independent of the current and energy of the bunch of charged particles.

14. The beam transport method of claim 12,
wherein said linear accelerator includes: a plurality of pulse-forming lines transversely extending to and serially arranged along the acceleration axis, each pulse-forming line having a switch connectable to a high voltage potential for propagating at least one electrical wavefront(s) through the pulse-forming line independently from other pulse-forming lines to produce a short acceleration pulse adjacent a corresponding short axial length of the acceleration axis; and
further comprising the step of sequentially activating said switches in groups of at least one switch(es) corresponding to a block of adjacent pulse-forming line(s) so that the groups of short acceleration pulses sequentially produced thereby form a traveling axial electric field that propagates along the acceleration axis in substantial synchronism with the injected bunch of charged particles to serially impart acceleration energy thereto.

15. The beam transport method of claim 14,
wherein said sequentially activating step includes timing the activation of a first switch group so that acceleration energy is first imparted to the injected bunch of charged particles along the predominantly rising edge and near the crest of the E_{z} energy waveform of the traveling axial electric field.

16. The beam transport method of claim 14,
wherein said sequentially activating step includes sequentially activating said switch groups so that said traveling axial electric field has an axial length that is greater than the injected bunch of charged particles.

17. The beam transport method of claim 14,
wherein said sequentially activating step includes performing alternating phase focusing by controlling the activation timing of each of the switch groups relative to a crest of the E_{z}(t) energy waveform of the traveling axial electric field so that acceleration energy is imparted to the injected bunch of charged particles along either a predominantly rising edge or a predominantly falling edge of the E_{z}(t) energy waveform of the traveling axial electric field.

18. The beam transport method of claim 12,
wherein said bunch of charged particles is extracted into the lens stack by controlling an upstream one of the two electrodes to function as an extraction electrode.
